(19) United States
(12) Patent Application Publication
(10) Pub. No.: US 2014/0351026 A1
(43) Pub. Date: Nov. 27, 2014

(54) COMPUTER BASED BALLOT SYSTEM AND PROCESS

(71) Applicant: DOSHMOSH PTY LIMITED, Manly, New South Wales (AU)

(72) Inventor: Peter Alexander Merel, Huntley's Point (AU)

(73) Assignee: DOSHMOSHPTY LIMITED, Manly, New South Wales (AU)

(21) Appl. No.: 14/368,275

(22) PCT Filed: Dec. 21, 2012
(86) PCT No.: PCT/AU2012/001597

§ 371 Date: Jun. 23, 2014

(30) Foreign Application Priority Data
Dec. 23, 2011 (AU) 2011905418

(51) Int. Cl. G07C 13/00; H04W 4/02

(52) U.S. Cl. CPC G07C 13/00; H04W 4/021; H04W 84/042
USPC 705/12

(57) ABSTRACT

The present invention relates to a computer based ballot system and apparatus enabling polling to be implemented by Wide Area Networks, such as the Internet. A user is able to cast a vote utilising a voting device in the form of a computing process, via a voting interface, which may be a distributed computing element, distributed by webpages. Persons may be able to place votes relating to the content of various webpages. Ballots are generated as a plurality of linked ballots, and when a vote is placed on one ballot the vote may propagate through the other ballots that are linked to it. The structure of the linkage between the ballots may be determined based on user input.

### FIELD OF THE INVENTION

The present invention relates to an improved computer based ballot system and apparatus and, particularly, but not exclusively, to a ballot system and apparatus enabling polling to be implemented via Wide Area Networks, such as the Internet.

The contents of the applicant's earlier filed International (PCT) Patent Application No. PCT/AU2011/000761 entitled “a computer based ballot system and process” and filed on 24 Jun. 2011, claiming priority from Australian Patent Application No. 2010902810 (priority date 25 Jun. 2010), is herein incorporated in its entirety.

### BACKGROUND OF THE INVENTION

In any democracy, the ability to ballot a population is an absolute requirement. Current balloting systems, however, are cumbersome and very expensive. The majority of existing ballot systems are still, for the most part, manually implemented.

Partly electronic systems are known where manually marked ballot papers are partially counted electronically. These still require an intense manual effort.

Because of the expense and effort required, there are limitations on how often ballots can be carried out. They are usually only carried out at intervals counted in years.

Another issue with current systems is the “one person one off vote” approach. A person gets one vote for a particular ballot which necessarily is implemented at a particular time. During the intervals between ballots (years) it is unlikely that the majority of people will have any other input into the democratic system.

Because of these limitations to conventional balloting, therefore, there are necessary limitations on the democratic input that a society's population can have in a democracy. The number of issues that a single voter is able to cast their vote on is very limited. Usually, the only ballots that they will take part in will be to elect representatives who will then make decisions on important issues on their behalf. These may not be decisions that they agree with. The chance to vote in ballots on particular issues is extremely limited, if available at all (eg referendum).

Global Wide Area Networks, such as the Internet, provide a vibrant forum where people can lead and discuss topics on particular issues. The “Blogosphere” is one of the largest uses of the Internet, where persons (“Bloggers”) provide opinions on a wide range of issues.

Bloggers are not the only Internet operators that comment on issues. Commentary is often found on Social Websites (eg opinions often expressed on Websites such as Facebook™, LinkedIn™, etc). Media Websites also provide opinion on current affairs, news items, etc.

Apart from counting the number of hits on these Websites there is no reliable way of assessing the success or otherwise of an article or comment on a particular issue, nor of assessing the preferences regarding this issue of users of a plurality of Websites. Further, revenue for such sites is generally restricted to registration fees and/or advertising.

The applicant's earlier International (PCT) Patent Application No. PCT/AU2011/000761, provides a computer based ballot system, for facilitating operation of ballots, comprising a ballot support arrangement which comprises a host computer process arranged to host a ballot, and to register and tally votes on the ballot in response to operation of a voting device comprising a computer process arranged to effect a vote in the ballot.

In an embodiment, the system further comprises a voting interface, via which a user is able to cast a vote using the voting device. In an embodiment, the voting interface comprises a distributed computing element arranged to allow remote access to the host computing process so a voter can cast a vote. In an embodiment, the voting interface may be distributed via a communications network, such as a global Wide Area Network, such as the Internet.

In an embodiment, the voting interface may be associated with a further distributed computing element, such as a hypertext document, for example, where the voting interface is being presented via the World Wide Web (WWW), for example. The voting interface may be implemented as a portlet within an associated document such as a Web page.

The voting interface is not limited to being presented via a Web document or the Internet. It could also comprise an interactive voice response message. It could comprise a mobile device application (eg an iPhone™ application) or any other distributed computing element which allows access to the host computing process.

In the embodiment where the voting interface is distributed via the WWW, a plurality of the voting interfaces may be available and presented in association with a plurality of Web pages, where they can be accessed by potential voters to facilitate casting of votes in ballots. A plurality of voting interfaces may be arranged for casting of votes in a single ballot. This has the advantage that voting in the ballot may be accessed at a plurality of points, eg via a plurality of Web pages, where the voting interface is distributed via the WWW.

In an embodiment, further distributed computing elements associated with the voting interface may present or be associated with content relevant to the particular ballot that the voting interface is linked with. For example, the further distributed computing element may be a Web page associated with content relevant to the ballot. The Web page may be presented by a blog, social network (eg Facebook™) or media interface (eg newspaper interface) or any other Web page or equivalent.

It is an advantage of at least an embodiment, that voting interfaces can be associated with content being promoted by a person such as a blogger, a media outlet, or the like, so that a voter may vote and may also be influenced by the content. Votes placed via the particular voting interface may therefore represent the effectiveness or clarity or importance or desirability of the associated content, or of the subjects to which it pertains. The votes can become a way of ranking the effectiveness or desirability of the associated content, or the subjects to which it pertains.

In an embodiment, the ballot support arrangement comprises a interface weighting process which is arranged to calculate an interface weight of each particular voting interface associated with a ballot, depending on the votes placed via that voting interface. The interface weight of a particular voting interface advantageously provides an indication of the effectiveness of the associated content (eg blog). This is an effective way to assess bloggers and media and other opinions, or of the subjects to which these blogs, media and other opinions pertain.

In an embodiment, the ballot support arrangement comprises a valuing process arranged to associate a value with each voting interface, dependent upon the votes cast via the voting interface. In an embodiment, the value associated with the voting interface can be used to calculate a payment to be made to the proprietor of or contributor to the Web page or equivalent computing element, which hosts the voting interface. The payment may be a monetary payment.

This embodiment therefore has the advantage that bloggers, media outlets, other proprietors of or contributors to Web pages or equivalent computing elements hosting voting interfaces may receive a source of revenue, based on voters voting via their pages. This may advantageously encourage these types of “channel partners” of the ballot support arrangement, to host voting interfaces.

The ballot support arrangement may host many ballots. Advantageously, utilizing a Wide Area Network such as the Internet to provide many voting interfaces, provides a simple and inexpensive way to allow voting on many issues. The ballot support arrangement is arranged to register and to tally the votes, and in an embodiment provide ballot rankings so the voters can assess how a vote is progressing on a particular ballot issue.

In an embodiment, the voting device comprises a vote and a voting time period, being a predetermined time period for which the vote remains valid. The vote therefore is a “metered vote”. When the vote is placed, the ballot support arrangement is arranged to monitor the time of placement and the voting time period. The vote remains effective for this voting time period eg 30 days. While the vote is effective, it affects the outcome of the ballot. Once the voting time period has expired, however, and the vote is no longer effective, the vote no longer affects the ballot. Providing a voter time period has the advantage of measuring voter commitment to a particular issue. If the voter is highly committed they will commit more time to the issue. The outcome of the ballot is measured by assessing the number of votes that are effective at any particular time for the ballot. The ballot is therefore an “asynchronous” ballot in this embodiment, that can be affected by ongoing voter preferences. This may lead to a more effective democratic process than the typical synchronised voting system.

In an embodiment, a voter may switch their voting device from one ballot to another (reassign their vote). A voting device may be retracted and held in a vote repository associated with a “owner” of the vote (ie voter). In an embodiment the vote repository may be an electronic wallet or equivalent repository computing process. The repository computing process may be hosted by the ballot support arrangement.

In an embodiment, the voting device comprises a voter identifier, arranged to identify the owner (voter) of the voting device. Advantageously, the voter identifier may operate to prevent the same voter from voting twice on the same ballot. In an embodiment, the ballot support arrangement comprises an identifier process arranged to check the voter identifier and determine whether a particular voter has already voted on a particular ballot, in which case a further vote on the particular ballot will be declined. In an embodiment, the voter identifier may be an identity of a device with which the user is associated, such as a mobile telephone, mobile computing device, pc, laptop, or other device. It may be an email address, or a registered association between a plurality of these identifiers.

In an embodiment, the voting device further comprises an associated value. In an embodiment, the associated value is a monetary amount which a voter must pay in order to obtain the voting device and therefore place a vote. The voter may therefore purchase their vote. In embodiments, this advantageously further facilitates demonstration of voter commitment. Payments need not be great but payment for a vote demonstrates the commitment of voters to particular ballot issues. Further, payment for the voting device results in a revenue stream which (as discussed above) in embodiments can be returned to channel partners representing or commentating on ballot issues, such as Bloggers.

In an embodiment, the ballot support arrangement hosts a plurality of ballots. In an embodiment, the plurality of ballots may be associated, such that an operation on one ballot may affect an operation on an associated ballot. For example, a vote in one ballot may propagate to affect a vote tally in an associated ballot. In an embodiment, ballots may be associated in the manner of an undirected graph. In an embodiment, ballots may be associated in the manner of a directed graph. In a further embodiment, ballots may be associated in the manner of a directed acyclic graph.

In one embodiment, ballots may be associated in the manner of a tree and may include parent ballots and child ballots, child ballots falling under the parent ballots.

Associating ballots may have the advantage of more realistically representing real life situations where issues are not generally isolated from each other, but are interconnected. For example, in traditional democracies, voters who differ on the particulars of a policy are generally assumed to agree on its context. For example, US voters disagreeing on the choice of Republican or Democrat still generally support the US Constitution. In an embodiment, a presidential ballot associated with a ballot issue representing a Democratic candidate (eg Obama) may be connected to a ballot where the associated issue represents “Democrats”. The parent ballot in this case represents Democrats and the child ballot represents Obama. In an embodiment, a vote for Obama propagates upwardly to the parent to also affect a vote for the Democrats. In an embodiment, a vote against Democrats propagates downwardly to affect a vote against Obama.

In an embodiment, the ballot support arrangement includes a ballot generating computer process which is arranged to generate hierarchically linked ballots. It may base the hierarchy on existing hierarchies, such as a sub-graph of the system of categories published by Wikipedia, for example.

In an embodiment, further ballots associated with existing ballots may be generated by users, eg hosts or authors of or contributors to Websites which include voting interfaces. These channel partners may add ballots as the children or peers of existing ballots utilizing the ballot generating computer process to link to existing ballots.

In an embodiment, these additional ballots may represent the conjunction or disjunction of a plurality of existing ballots, or any Boolean function based on existing ballots.

In an embodiment, the host computer process comprises a vote tally process arranged to tally votes in a ballot. In an embodiment, the ballot is associated with a ballot issue and a vote can be placed “for” (positive effect on result) or “against” (negative effect on result). In an embodiment, the vote tally process is arranged to tally positive and negative votes and calculate a ballot result comprising a function of the positive and negative votes.

In an embodiment where there are a plurality of ballots associated with each other, the vote tally process may be arranged to count votes from associated ballots towards a ballot being tallied. That is, votes towards associated ballots affect the result in the ballot being counted. In the embodiment where ballots are hierarchically linked in parent and child form, a positive vote in a child ballot propagates upwardly to effect a positive vote in a parent ballot. A negative vote in a parent ballot propagates downwardly to effect a negative vote in a child ballot.

In an embodiment, the vote tally process is arranged to rank ballots depending upon the vote tally. In an embodiment where ballots are associated, the vote tally process may be arranged to rank associated ballots with respect to each other. In an embodiment where ballots are hierarchically linked in parent and child manner, a plurality of children of one or more parent ballots may be ranked with respect to each other.

In an embodiment, the ballot support arrangement comprises a host computer process interface, which allows users access to ballots supported by the ballot support arrangement. The host computer process interface may be implemented as a Web interface, as a mobile device interface (eg mobile telephone, mobile internet, or other) or other type of interface. The host computer process interface, in an embodiment, enables a voter to navigate through ballots, and to vote in one or more ballots. In an embodiment, the host computer process interface has links with channel partner interfaces which may host voting interfaces. For example, links may be provided to Web pages hosted or contributed to by channel partners. In this way, a voter navigating via the host computer process interface, may obtain access to content provided by channel partners, which may be associated with or commented upon or be otherwise relevant to the ballot issues associated with one or more ballots. Advantageously, in an embodiment, the host computer process interface may be used as a content hub, allowing users to navigate links to interfaces having relevance to ballot issues.

Another of the fundamental requirements of any democratic system is veracity of the ballot process. It is important that the ballot process be transparent, so that the legitimacy of any ballot can be confirmed. In an embodiment of the invention of PCT/AU2011/000761, the computer based ballot system further comprises an audit interface, enabling persons to audit ballots to determine the veracity of the ballot process. In an embodiment, all vote data, relating to votes placed in ballots, is downloaded periodically to an audit repository, the audit repository being accessible by persons via the audit interface, to enable auditing. The audit repository may be available to the public. In one embodiment, the audit repository is available over a computer network, such as the Internet.

Embodiments have the advantage that complex hierarchical ballots may be implemented by way of Wide Area Networks such as the Internet, and ballot issues may be voted upon and counted, in a manner consistent with their customary meanings. Time metered votes measure current voter commitment, and allow voters to retract or change their votes over time. Channel partners may earn revenue by encouraging voters to vote via their channels.

The applicant's have developed improvements and alternatives to the system of International (PCT) Patent Application No. PCT/AU2011/000761.

### SUMMARY OF THE INVENTION

In accordance with a first aspect, the present invention provides a computer based ballot system for facilitating operation of ballots, comprising a ballot support arrangement which comprises a host computer process arranged to host a ballot, and to register and tally votes on the ballot in response to operation of a voting device comprising a computer process arranged to effect a vote in the ballot, and a ballot generating computer process which is arranged to generate linked ballots in response to user input, the structure of the linkage between the ballots being determined based on user input.

In an embodiment, users can originate ballots by originating “Opinions”. In an embodiment, the ballot generating computer processes is arranged to determine the linkage based on the use of Context and Subject for each Opinion. In an embodiment, Subject and Context tags are used to identify the Subject and Context to the ballot generating computer process.

In an embodiment, this leads to the ballot generating computer process forming a structure of ballots based on a semi-lattice of context nodes to ordered sets of subject. An Opinion links a single Subject to a single node in the context semi-lattice and thereby to all of its ancestors in the ballot space.

In an embodiment, ballots are associated by the linkage structure, and votes may propagate via the linkage in a similar manner to embodiments of applicant's earlier International (PCT) Patent Application No. PCT/AU2011/000761. The association via the user built linkage, is different from the association of applicant's earlier invention, which, in the preferred embodiment, is a tree hierarchy. The association of this embodiment of the present invention is a context semi-lattice map to ordered sets of subject nodes. In an embodiment, all votes may propagate “upwardly” through the lattice. In an alternative embodiment, positive votes may propagate upwardly and negative votes downwardly in the lattice. It is preferred, however, that all votes, positive or negative, propagate upwardly.

In an embodiment, the use of tags to represent Contexts and Subjects enables the ballot generating computer process to build the ballot space and connect the Contexts and Subjects in the appropriate relationship.

In an embodiment, votes may propagate for and against competing Subjects. Opinions are grouped by context and votes may be tallied for and against competing subjects.

In an embodiment, content may be associated with a particular opinion. For example, the user may input content to associate with an opinion that they may have created. In another embodiment, a content provider (who may be a channel partner) may attach content to one or more opinions and/or subjects. This content may be accessible when a user accesses a ballot.

Ballots may be accessible via any networks, and may be accessible via social networks, such as Facebook™.

In an embodiment, a tally computing process is provided which is arranged to apply rules to tally votes and apply weights and rankings to the ballots.

In an embodiment, each Opinion has a total of agreeing and disagreeing votes. The total votes agreeing with an opinion are the Positive Votes and the total votes disagreeing are its Negative Votes.

In an embodiment, a tally or “weight” may be applied to a user. In an embodiment, the weight of a user is the sum of the weight of all opinions that they originate. An Opinion's weight in this example being defined as its positive votes plus its negative votes.

In an embodiment, users may be rewarded based on votes and weights.

In an embodiment, Subjects of opinions may also have a ranking.

In an embodiment, the system comprises a reward calculation process arranged to calculate rewards for users of the system.

In an embodiment, users may be rewarded for registering on the system e.g. via a social network or other registration process.

They may also be rewarded when they develop and post an opinion.

In an embodiment, rewards may be monetary, and in an embodiment may be based on providing voting devices to the user, which may later be cashed in for value or, alternatively, used to place votes.

In an embodiment, rewards may be based on daily activity of the user. If the user is active, they may receive rewards.

In an embodiment, the system further comprises a behavior assessment process, which is arranged to determine patterns of voting and/or opining behavior of users of the system. In an embodiment, the behavior assessment process enables the system to determine users with similar behaviors, and users with dissimilar behaviors.

In an embodiment, the behaviors of users may be used to connect users, or, facilitate connection between users e.g. similar users may be connected to each other.

In an embodiment, the behavior assessment process may be used to present the users with ballots that are most associated with their particular behavior patterns e.g. presenting users with ballots similar to those that they may already have voted on.

In an embodiment, the system further comprises a geographic association process, which is arranged to associate a geographic location with a ballot and/or a Subject. In an embodiment, the system enables users to interface with the system using devices which can identify user's location e.g. mobile devices such as Smart Phones or the like.

In an embodiment, material may be presented to the user depending on geographic location e.g. a particular opinion and/or subject associated with a number of opinions may be presented to the user in a particular geographic location.

In an embodiment, the opinion and/or subject and/or ballot presented may depend on the time as well as the location of the user. The time may be the time of day, day of week, or calendar events.

In an embodiment, the geographic association process may identify a plurality of users in a particular geographic area and present votes or opinions from the one user to be presented to the other user, and vice versa.

In accordance with a second aspect the present invention provides a computer based ballot system for facilitating operation of ballots, comprising a ballot support arrangement which comprises a host computer process arranged to host a ballot, and to register and tally votes on the ballot in response to operation of a voting device comprising a computer process arranged to effect a vote in the ballot, and a ballot generating computer process which is arranged to generate linked ballots in the form of Opinions, the linkage being based on the use of Context and Subject for each Opinion.

In an embodiment, Subject and Context tags are used to identify the Subject and Context to the ballot generating computer process.

In accordance with a third aspect, the present invention provides a computer based ballot system for facilitating operation of ballots, comprising a ballot support arrangement which comprises a host computer process arranged to host a ballot, and to register and tally votes on the ballot in response to operation of a voting device comprising a computer process arranged to effect a vote in the ballot, and a behavior assessment computer process, which is arranged to determined patterns of voting and/or opining behavior of users of the system.

In an embodiment the behavior assessment processes arranged to determine users with similar behaviors, and users with dissimilar behaviors.

In accordance with a fourth aspect, the present invention provides a computer based ballot system for facilitating operation of ballots, comprising a ballot support arrangement which comprises a host computer process arranged to host a ballot, and to register and tally votes on the ballot in response to operation of a voting device comprising a computer process arranged to effect a vote in the ballot, and a geographic association process which is arranged to associate a geographic location with a ballot or a Subject of a ballot.

In an embodiment, the system may be arranged to present material to the user depending on geographic location.

In accordance with a fifth aspect, the present invention provides a computer based ballot system for facilitating operation of ballots, comprising a ballot support arrangement which comprises a host computer process arranged to host a ballot, and to register and tally votes on the ballot in response to operation of a voting device comprising a computer process arranged to effect a vote in the ballot, and a ballot generating computer process which is arranged to generate linked ballots, the linkage being based on the use of a Context and a Subject for each of a plurality of Opinions.

In accordance with a sixth aspect, the present invention provides a method of arranging ballots, comprising the steps of registering and tallying votes on ballots in response to user ballot input, and linking ballots in response to user ballot input, the structure of the linkage between the ballots being determined based on user ballot input.

In accordance with a seventh aspect, the present invention provides a method of arranging ballots, comprising the steps of registering and tallying votes on ballots in response to user ballot input, and linking ballots in response to user ballot input, the step of linking the ballots comprising generating linked ballots in the form of Opinions, the linkage being based on the use of Context and Subject for each Opinion.

In accordance with an eighth aspect, the present invention provides a method of arranging ballots, comprising the steps of registering and tallying votes on ballots in response to user ballot input, and assessing behaviour of users based on patterns of voting and/or opining behaviour of users.

In accordance with a ninth aspect, the present invention provides a method of arranging ballots, comprising the steps of registering and tallying votes on ballots in response to user ballot input, and associating a geographic location with a ballot or a Subject of a ballot.

In accordance with a tenth aspect, the present invention provides a method of arranging ballots, comprising the steps of registering and tallying votes on ballots in response to user ballot input, and linking ballots, the linkage being based on the use of a Context and a Subject for each of a plurality of Opinions.

### BRIEF DESCRIPTION OF THE DRAWINGS

Features and advantages of the present invention will become apparent from the following description of embodiments thereof, by way of example only, with reference to the accompanying drawings, in which:

FIG. 1 is a schematic diagram of a system in accordance with an embodiment of the invention of International (PCT) Patent Application No. PCT/AU2011/000761.

FIG. 2 is a representation of a network display (in this example, Web Page) hosting a voting interface of the system of FIG. 1;

FIGS. 3a and 3b are schematic representations of hierarchically linked ballots, which may be supported by the system of FIG. 1;

FIG. 4 is a further schematic representation illustrating hierarchically linked ballots which may be supported by the system of FIG. 1;

FIG. 5 is a further illustration of hierarchically linked ballots that may be supported by the system of FIG. 1;

FIG. 6 is a diagram illustrating the operation of metered votes in a ballot supported by the system of FIG. 1;

FIG. 7 is a flow diagram illustrating operation of a voting interface of the system of FIG. 1, in association with a “Blog” Web Page;

FIG. 8 is a flow diagram illustrating operation of a voting interface in association with a Social Site Web Page;

FIG. 9 is a diagram of a host computer process interface illustrating ranking of ballots supported by a system in accordance with the embodiment of FIG. 1;

FIGS. 10a, b and c, illustrate further situations where voting interfaces supported by the system of FIG. 1 may be implemented;

FIG. 11 is a representation of a computer display illustrating implementation of voter interfaces supported by a system of the embodiment of FIG. 1, in association with a media outlet;

FIG. 12 is a diagram illustrating a hierarchically linked ballot and an operation of adding a further ballot;

FIG. 13 is a representation of a graphical display illustrating time dependent results of a ballot supported by a system of the embodiment of FIG. 1;

FIGS. 14a to c are representations of example displays in accordance with an embodiment of the invention, illustrating an example user experience;

FIGS. 15a to t are representations of computer displays generated in accordance with an embodiment of FIG. 1, illustrating further example user experience;

FIGS. 16a through i are further representations of computer displays generated in accordance with an embodiment of the invention of International (PCT) Patent Application No. PCT/AU2011/000761, illustrating yet further user experience with the system of this embodiment, and

FIGS. 17a to d are further example representations of computer displays generated by the system in accordance with an embodiment of the invention of International (PCT) Patent Application No. PCT/AU2011/000761, illustrating yet a further user experience;

FIG. 18 is a schematic diagram illustrating how ballots can be built from Opinions with Context and how they can be connected by Subjects, in accordance with an embodiment of the present invention.

FIG. 19 is a schematic representation illustrating hierarchal linked ballots in accordance with an embodiment of the present invention;

FIG. 20 is a further schematic representation of linked ballots illustrating operation of an embodiment of the present invention;

FIG. 21 is a representation of an interface showing a plurality of Context connected ballots in accordance with an embodiment of the present invention;

FIG. 22 is a flow diagram illustrating one monetization model for operation of a system in accordance with an embodiment of the present invention;

FIG. 23 is a flow diagram illustrating operation of a system in accordance with an embodiment of the present invention;

FIG. 24 is a flow diagram illustrating operation of a system in accordance with an embodiment of the present invention,

FIG. 25 is a representation of a type of interface which may be presented in accordance with an embodiment of the present invention.

### DETAILED DESCRIPTION OF EMBODIMENTS

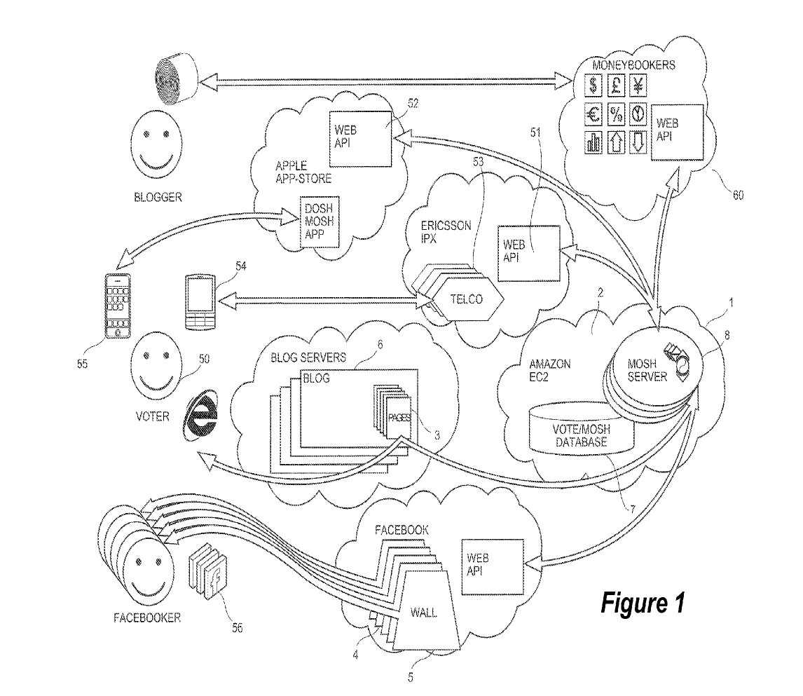

Referring to FIG. 1, a computer based ballot system in accordance with an embodiment of the invention of PCT/AU2011/000761 is illustrated schematically. The ballot system comprises a ballot support arrangement generally designated by reference numeral 1. In this example, the ballot support arrangement 1 comprises a host computer process supported by a computing system 2, arranged to host a ballot. The ballot support arrangement is also arranged to register and tally votes on the ballot issue in response to operation of a voting device which comprises a vote computer process arranged to effect a vote in the ballot.

In this embodiment, the host computer process is supported by computing system platform 2 which comprises a server 8 and database 7. The server 8 may comprise appropriate hardware to provide interfaces over a network, such as the Internet. Server 8 may serve a Web interface to client computers (reference numeral 4) and receive communications from those client computers. It may also provide communications with mobile devices 54, 55, eg mobile Web or other communications. The host computing process may be supported by a cloud computing system or by proprietary server/database arrangement.

The embodiment is not limited to implementation via a client/server network architecture and may be implemented by any appropriate computing architecture, including mainframe/terminal architecture, a stand alone computer, or any other architecture.

The functionality as described in the following pages, may be implemented by any appropriate computing hardware and software arrangement. The computer hardware may incorporate random access memory, read only memory, disk storage or other large capacity storage. Transceivers for transmitting over the net and appropriate network infrastructure will also be provided. Processors will also be implemented either by single or multiple microprocessors.

In this embodiment, the system further comprises a voting interface 3, 4, arranged to be generated by the ballot support arrangement and via which a user is able to cast a vote using the voting device. In this embodiment, the voting interface 3, 4 comprises a distributed computing element arranged to be presented to a user via a computing system 5, 6, and allowing remote access to the host computing process. In this embodiment, the computing systems 5, 6 are computers connected in a Wide Area Network, in this embodiment the Internet. In this embodiment, the distributed computing element is a portlet to the ballot support system, presented via WWW pages. The distributed computing element may also be an application arranged to be hosted by a mobile device, such as a mobile telephone or personal digital assistant (54, 55). The application is arranged to interface with the host computing process.

In the accompanying drawings, various colloquial names have been used for components of the system of this embodiment. It will be appreciated that these names are not limiting, and are merely colloquialisms which may be used as trade variants or brands for components of the implemented system. The key to the terminology used in the drawings is as follows:
Ballot and linked hierarchical ballots=Mosh™ or Moshes
Voting device=Dosh™
voting interface=MoshPit™

This terminology is not limiting. It is intended that this terminology may be used in commercial implementation, as trade marks associated with the technology.

The ballot support arrangement 1 supports ballots by providing a ballot database 7 which stores ballot data relating to ballots and associated ballot issues. Ballot data is served by appropriate servers 8 to computer systems linked in the network (eg 5, 6).

The ballot support arrangement is arranged to count votes allocated to ballots and provide results. The database stores allocated votes with respect to their corresponding ballot. The database 7 also stores vote data, such as the term of the vote (see later).

In this embodiment, the ballot support arrangement 1 is arranged to host a plurality of ballots that are hierarchically connected to each other. The ballots include parent ballots and child ballots, the child ballots falling under the parent ballots. Each ballot is associated with a particular ballot issue in the hierarchy.

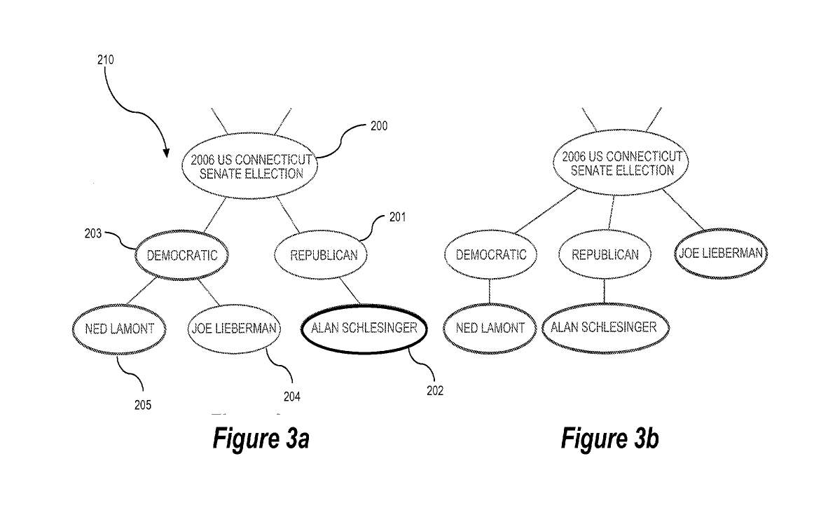

FIGS. 3a and 3b show the hierarchy of ballots as nested distinctions. In this embodiment a ballot 200 represents an agreement and a contest among a set of published opinions. The hierarchy 210 of ballots operates as a multiple choice poll where each choice 201, 203, 202, 204, 205, represents a more specialized poll.

Consider the electoral contests in a traditional democracy. Each contest is framed by an agreement. A contest for the presidency of the USA is based on an agreement that there should be a country called the USA with a system of laws maintaining a president as detailed in the US constitution.

Every election entails two or more distinct preferences. Voters adopting one of these preferences are in agreement with each other. They may still disagree on distinct parameters of this agreement. So contests are generally composed of competing agreements, each of which contains more specialized contests. An agreement that contains a more specialized contest is implemented in this embodiment as a series of hierarchically linked ballots (for example, the hierarchically linked ballots generally represented by reference numeral 210 in FIG. 3a).

In math such a composite of distinctions may be regarded as a Hausdorff space. In software, in this embodiment, the space of all linked ballots may be modeled as a tree. Each ballot contains distinct neighborhoods, the “sub-ballots” which specialize its preference. For example, referring to FIG. 3a, ballot 203 is a vote for or against DEMOCRAT. The sub-ballots, 204 and 205, of DEMOCRAT are specializing the ballot DEMOCRAT to particular democrat candidates, in this case NED LAMONT and JOE LIEBERMAN. Each ballot is held to completely agree with its containing parent ballot, and to otherwise completely disagree with its peer ballots. For example, in FIG. 3a, peer ballots are DEMOCRAT 203 and REPUBLICAN 201, which obviously completely disagree with each other.

In more detail, FIG. 3a illustrates a part of Ballot-Space. Here one ballot, 2006 US CONNECTICUT SENATE ELECTION, has two sub-ballots DEMOCRATIC and REPUBLICAN. The Republican ballot has one sub-ballot, ALAN SHLESSINGER. The Democratic ballot has two sub-ballots, NED LAMONT and JOE LIEBERMAN. In 2006 the Democrats seemed set to defeat the Republicans in Connecticut. In the event the incumbent Lieberman lost the primary to Lamont. Lieberman re-entered the race as an independent (FIG. 3b), drawing both Democratic and Republican votes to win the election.

Ballots, in this embodiment, account for a superset of electoral semantics including reassignment of voting devices (votes) to new ballots to account for changes of construction, as in this Lieberman race. In contrast to a traditional election a ballot supported by the system of this embodiment is not permanently won or lost. Its function is not limited by a deadline or event and it need not refer to a contest among candidates for an office. It closes, compares and ranks sub-ballots according to their respective “weights” of voting devices to indicate the immediate collective preference among all interested users. In this embodiment, the host computer process comprises a vote tally process which is arranged to calculate the weight of a ballot based on rules applied for determining a ballot outcome. In this embodiment, as will be discussed in more detail later, each ballot may have a weight which is the number of voting devices currently voting in that particular ballot (the Direct Weight). It can also have an Aggregate Weight, relating to the number of votes currently voting in its parent and sub-ballots. Because a voting device comprises a time period in this embodiment (the votes are metered), the weights of a particular ballot relate only to votes that are current. Further, the ballot results dynamically vary, depending upon the number of current voting devices affecting the ballot.

In this embodiment, the ballot support arrangement includes a ballot generating computer process which is arranged to generate the hierarchically linked ballots. It may base the hierarchies on existing hierarchies and in one embodiment bases the hierarchy on the category system supporting Wikipedia.

The hierarchy of all ballots is referred to in this document as “Ballot-Space”. Ballot-Space forms a strict tree, but is generated by reference to the world's broadest pre-formed ontology, the graph of categories freely available on Wikipedia. There are about 500,000 Wikipedia categories at this time, and the ballot support system in this embodiment comprises a ballot generating computer process which is arranged to harvest and filter their key relations to generate a Ballot-Space. In an embodiment, the method is as follows:
1. The Wikipedia categories do not form a tree. In principle they are a directed acyclic graph, but in practice they contain cycles. To eliminate these cycles we traverse the Wikipedia hierarchy from the leaves up to the root, ignoring any path that encounters duplicate nodes. This normalizes the graph to a strict directed acyclic graph (DAG).
2. This page covers the entire non-administrative contents of Wikipedia. Let's call that “Ballot Level 0”. Excluding “Topical Indexes” and “Categories by Topic”, we call the children of Ballot Level 0 “Ballot Level 1”.
3. Now we scan the Wikipedia category lattice for pages in any category descending from Category: Controversy. These are pages of long-standing disagreement and subject sensitivity. For each of these, we trace the shortest path up to each of the members of Ballot Level 1. We ignore all longer paths.
4. It's okay for a page to have more than one shortest path to Ballot Level 1 so long as each duplicate path leads to a different member of Ballot Level 1.
5. Multiple shortest paths leading from a page to a member of Ballot Level 1 are pruned by preferring paths with a larger total descendant page populations. Any remaining ambiguity is pruned manually.
6. We merge all these paths node by node. Wherever this merging results in a node with two or more parent paths to different Level 1 ancestors, we split (clone) that node per ancestor to make distinct paths for each. This will result in a spanning tree for all controversies in Wikipedia. Ballots created in this way are called Standard Ballots.
7. Another possible method to derive a tree of Standard Ballots from Wikipedia is simply to drill down from a root category to a certain depth—say four levels deep—and then turn this graph into a tree by cloning any nodes with multiple parentage on a parent basis.
   The ballot generating computer process in this embodiment of this invention enables additional ballots to be linked to the Standard ballots by “channel partners” who are presenting voting interfaces, for example. A channel partner may, for example, be a Blogger, who is providing comment associated with a ballot. The system of this embodiment enables extension of the standard ballots by the channel partners, using two mechanisms.
      1. The first requires us to store the database of the SKOS categories for all Wikipedia as normalized per step 1 above. When creating a new ballot a Blogger may, starting with any existing Standard ballot, choose from a list of sub-categories of that ballot, then sub-categories of those sub-categories, until arriving at a suitable ballot for their purpose. The Blogger is required to vote for this ballot before it is added to Ballot-Space.
      2. It may be that the user's intent is not served even by the elaborate Wikipedia classification system. So a ballot may also be created by writing in the name of a new sub-ballot for any existing ballot. Such a “write-in” ballot may undergo a process of automated review or human review via the ballot support arrangement.
   Ballots created in these ways are called User Ballots. Unlike Standard ballots, User Ballots require a minimum weight of 2 votes to establish and maintain their visibility in the Ballot-Space host computer process interface described below.

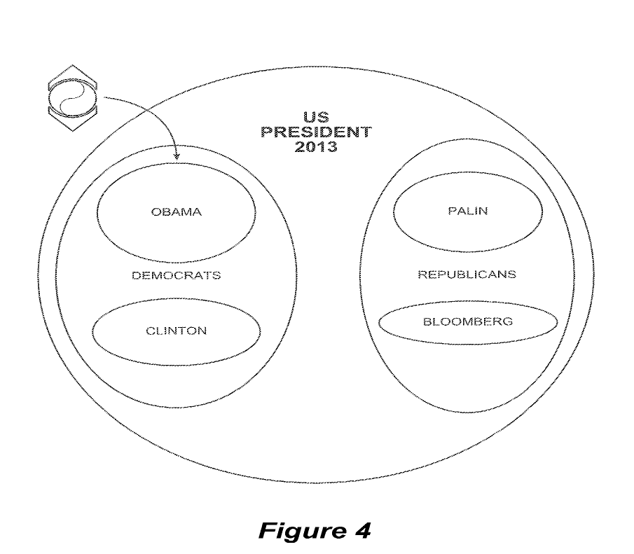

FIG. 4 shows part of a Ballot-Space for ballots relating to Democrats, Republicans and sub-ballots relating to Democrat and Republican identities (OBAMA, CLINTON, PALIN, BLOOMBERG).

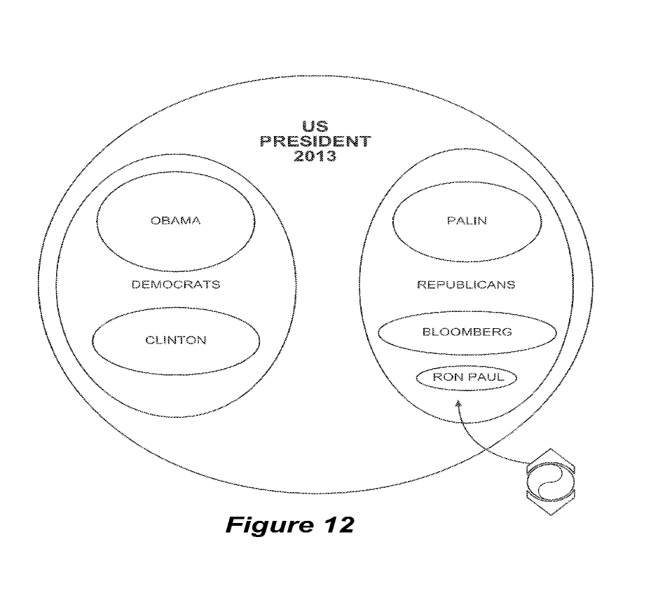

A Blogger wishes to add a further ballot, representing a further Republican candidate (RON PAUL). Referring to FIG. 12, using tools provided by the ballot generating computer process a Blogger adds Ron Paul to the Republican sub-ballots (candidates). This user ballot requires a minimum weight of two votes to establish and maintain visibility in the Ballot-Space.

It is advantageous to have the Ballot-Space conform to a tree, for the following reasons:
So single ballots can not gain unfair Aggregate Weight (see later in description) by confusing their roles in different contexts. For example, so that the weight of a ballot “Barack Obama” can not be inflated by the trick of multiple inheritance from “Impeach Obama” and Re-elect Obama”.
To prevent a spam vote from affecting multiple ballots. The system already deprecates spam; spammers must pay a monetary value for every vote per ballot to promote some URL (see later). Due to one-man-one-vote, however, and the attention economy device in the UI described below, spam simply becomes too expensive to scale.
So that users don't try to game strategic implications of ballot parentage. That would complicate the host computing process interface and social dynamics without any benefit to voters. Voters expect a clearly factored hierarchy of destinations, not a tricky game with lots of confusing strategy.

In a further embodiment of the system, a set of “editorial ballots” are established by the system to enable users to collaboratively create and refine the standard ballots.

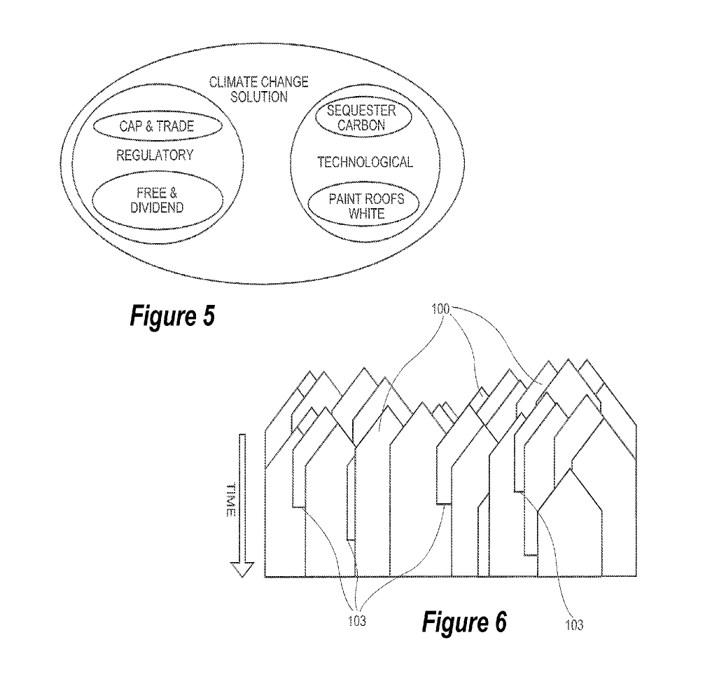

Ballots are not just limited to issues relating to candidates in politics. Any issues can be voted on. FIG. 5 shows a section of the Ballot-Space with issues relating to climate change. Ballots include whether the climate change solution should be REGULATORY or TECHNOLOGICAL. Regulatory sub-ballots include CAP AND TRADE and FEE AND DIVIDEND. Technological sub-ballots include SEQUESTOR CARBON and PAINT ROOFS WHITE. As will be appreciated, ballots may deal with any number of issues.

In this embodiment votes are placed via voting interfaces, generated by the Ballot support arrangement, via which a user is able to cast a vote using the voting device. In this embodiment, the voting interface comprises a distributed computing element which is arranged to be presented to a user (voter) via a network, such as the Internet. In this embodiment, one implementation of the voting interface is as a portlet associated with a Web interface, such as a Web Page. The portlet links back to the ballot support arrangement, so that votes can be placed in ballots supported by the ballot support arrangement. Other implementations of the voting interface may include an application on a mobile device, such as a mobile phone or PDA.

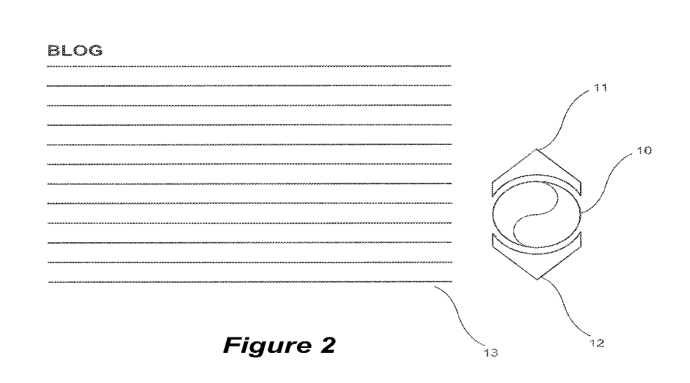

In this embodiment, the voting interface distributed computing element is associated with a further distributed computing element. In this embodiment, it is associated with a Web page or equivalent further distributed computing element presented over the network. Users may therefore vote via Web pages which contain the voting interface. The voting interface is termed MOSHPIT™ in the drawings accompanying this description.

Where the voting interface is presented via WWW, Web pages may be presented by channel partners such as Bloggers, Social Network interface (eg Facebook™), media interfaces (eg newspaper interfaces) or any other Web page or equivalent. FIG. 2 illustrates a voting interface 10 for a ballot relating to Obama. Voting via arrow 11 (Up) indicates a Positive vote and voting via arrow 12 (Down) indicates a Negative vote. Clicking on the “globe” symbol 10 enables access to a host computer process interface (eg Web interface) for the Ballot-Space, via which the user can navigate through the Ballot-Space.

The Blog script 13 associated with the page may discuss issues relating to the ballot.

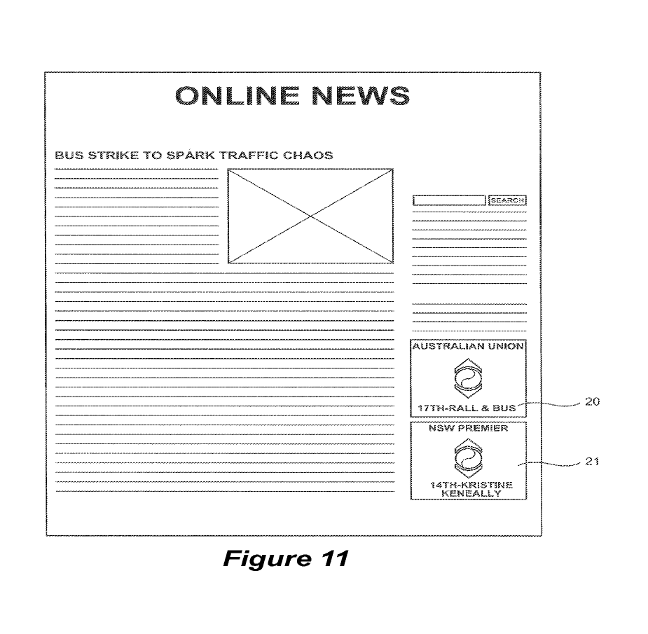

FIGS. 10a, b and c provide more illustration of the type of issues that voting interfaces and ballots may be associated with:
FIG. 10a, ballots on speakers and acts for thought leading events eg are you for or against this speaker or act (voting interface, reference numeral 15).
FIG. 10b, sporting events, are you for or against particular teams in a sporting event (voting interfaces reference numerals 16 and 17).
FIG. 10c, voting interfaces 18, 19 associated with advertising campaigns and promotions ie are you for or against the brands illustrated?

Voting interfaces may also be placed in association with news media. See FIG. 11 and voting interfaces 20 and 21 allowing votes for or against the particular issues discussed in the associated content 22 on the media page. In the illustrated example there are illustrated two voting interfaces to different ballots. One ballot issue is whether to be for or against a particular Australian Union (the contest may relate to ranking of Australian Unions) and the other voting interface 21 relates to a ballot for or against a particular candidate for NSW Premier (which may be a sub-ballot of a ballot for ranking of NSW Premiers).

A voting interface may be associated with any computer Web page or equivalent.

The voting interface portlet links back to the ballot support arrangement so that votes can be placed via the voting interface and a weighting of the voting interface (and therefore associated comments expressed) can be calculated (see later).

In more detail, a voting interface in this embodiment is an AJAX portlet that enables the author/editor of any Web page to promote their preferred ballot to their readers.

In this embodiment the system enables a Blogger (or any other channel partner) to paste a simple block of HTML into their Web page to invoke the voting interface portlet, just as they do presently to transclude Google™ AdSense™ and similar widgets.

The voting interface enables readers to both acquire a voting device via PSMS and to auto-allocate it to a corresponding ballot with an absolute minimum of Web interaction—a single click for an existing user whom the system identifies by IP/Cookie, or one click plus the digits of their phone number for a new user (see later).

The voting interface that appears on the Web page is represented in the form of a stylized “logo”. See FIG. 2 items 10, 11 and 12 and other figures containing a view of the voting interface.

There are a number of incentives to motivate channel partners pasting voting interface on their site pages. They include:
Whenever a user employs a voting interface to purchase a voting device, a portion of the purchase price of the voting device may be allocated directly to the Blogger hosting the voting interface.
Community: Most Bloggers wish to associate their pages with pages on related and opposing blogs. Under this embodiment, Bloggers don't have to explicitly refer to these blogs—they just determine their preferred ballot and this automatically creates associations in the corresponding host computing process interface view (see later). This is similar to tagging sites like technorati, dig and newsvine, but superior because Bloggers can purchase a voting device themselves to obtain immediate social recognition without depending on readers to tag them or other Bloggers to link them.
Viral marketing: The Blogger announces a rising weight for his preferred ballot as a way of expressing pride and righteousness. He trumpets a falling weight as a cry for help from his readers and compatriots. And he reaches out to his compatriots, asking them to direct their voting interfaces to the same ballot he does so that their collective interest will rise against their competitors. When respected bloggers adopt voting interfaces on the basis of revenue or social mobility, their compatriots will adopt them in order to show solidarity and to “be cool”.

As discussed above, embodiments of the ballot system of the present invention comprise voter devices, which a voter is able to use to place a vote via a voting interface. The voting device (Dosh™) comprises in this embodiment a voting computer process which supports the functions of the vote, vote time, vote cost, vote destination (what ballot is the vote for?), vote origin (what voting interface was the vote placed by?). The voting device represents a voter preference for or against some particular alternative for a voter-specified time period. The voting device comprises:
a vote;
a vote purchase cost;
a vote time period (how many “vote-days” will the vote last for?);
voter identifier.

This can depend on the purchase price for the vote.

The voting device may be associated with a URL for some page on the Web that recommends the ballot. The URL will generally be associated with the voting interface via which the vote is placed.

The voting device will also be associated with a ballot destination.

The voting device is a metered vote, lasting a predetermined time period. The ballot represents a ballot category for the opinion in relation to all comparable opinions. The ballot system enables combination of users' voting devices and ballots in contest to rank all published opinions on line.

The voting device also comprises a voter identifier, which identifies the voter. In this embodiment the identifier is associated with a device with which the user is associated, such as a mobile telephone, mobile computing device, PC, laptop or other device. The ballot support system comprises an identifier process arranged to check the voter identifier and determine whether a particular voter has already voted in this ballot, in which case a further vote will be declined. The voter identifier facilitates the system ensuring one vote per user per ballot. A voter cannot vote twice in the same ballot without purchasing a separate mobile device to provide a separate voter identity. Vote “rigging” by voting more than once, is therefore unlikely, as it would be prohibitively expensive.

The ballot support arrangement in the system of the present invention enables voting devices to be purchased via a number of avenues.
1. A voting device can be purchased by a user accessing a page having a voting interface and wishing to vote in the ballot associated with the voting interface. See reference numeral 50, FIG. 1. The user purchases a voting device by entering their mobile phone number (or ID of equivalent device) via the voting interface portlet. The ballot support arrangement 1 then triggers an MT-PSMS or WAP-billing dialogue via the user's mobile phone or equivalent device to confirm their purchase. User confirmation results on their phone in a non-refutable charge to the user's monthly bill. Within 60 days of purchase the SMS aggregator deposits the user's payment in an account associated with the system. This revenue can then be used to go towards the system and also to pay the channel partners, such as Bloggers.
   If the sale is the first time the user has used the system, a password may be allocated and may be registered in the database 7. The password may be used to authenticate the user to enter the host computing process interface (in this case being in the form of a system Website hosted by the cloud too.
2. Voting devices may be purchased directly from the system via Web interfaces, see reference numerals 51 and 52. For example Web interface 51 may be associated with purchase from a telecommunications company 53 via a mobile phone device 54. Mobile computing devices 55 (which may also be mobile telephones may be able to purchase voting devices from Web API 52 associated with an application provider such as Apple™ applications. This unallocated voting device (ie, not associated with a ballot that a voter has purchased their voting device from) may be stored in a vote repository, such as an electronic wallet via an application on their mobile device and/or within the database 7. This unallocated voting device can be used to vote in any ballot.

The requirement to purchase voting devices results in revenue flowing into the system eg via telcos and other voting device “channel providers”. This revenue can be used to provide an incentive to channel partners hosting ballots. In this embodiment, a proportion of the revenue may be paid to Bloggers, media partners or other channel partners that host voting interfaces. In this embodiment, a interface weighting process of the system 1 calculates a weight of a voting interface. The weight depends upon the amount of votes that are placed via the voting interface. This can give a direct indication of voters who are accessing the ballot via the voting interface and the associated channel partner interface (eg Web page). This can give an indication of the value placed, for example, on a Blogger's comments by the public accessing the ballot via that Blogger's Web page. The system also comprises a valuing process, which can be used to calculate an amount of revenue to pay the blogger. In this embodiment, the revenue is a proportion of the purchase cost of each vote (placed via the voting interface). The valuing process may calculate revenue in different ways. The Blogger has an incentive to channel votes via his voting interface, and therefore to write his blogs to attract voters' opinions. Calculation of the value to provide the channel partner is carried out by the system 1 and the channel partner may be paid via Web application interface and system 60.

The value of revenue paid to a channel partner may, in an embodiment, depend upon a rank associated with the channel partners voting interface calculated on the basis of rules which are detailed later on in the specification.

The revenue provided via the system can provide an alternative and additional source of revenue for all channel partners, such as Bloggers, media outlets, and other channel partners.

Because of the time-metered nature of the votes, the ballots are dynamic. The weight of the ballot can vary over time, depending upon how many votes are allocated at any particular time.

Voters and channel partners can access a host computing process interface (eg web interface) in the system 1 at any time to check the time dependent outcome of any ballot. Further, the system 1 may notify mobile devices 54, 55 of the voter of ballot results, to keep them updated and involved.

FIG. 6 illustrates the time dependent nature of the votes. Each vote is indicated by the arrow 100. The apex of the arrow indicates votes being placed. The time axis of the graph indicates progression of the ballot. Where an arrow ends indicates that the vote has either been reassigned or its time has expired, reference numeral 103. Once a vote has expired, it no longer counts to the ballot.

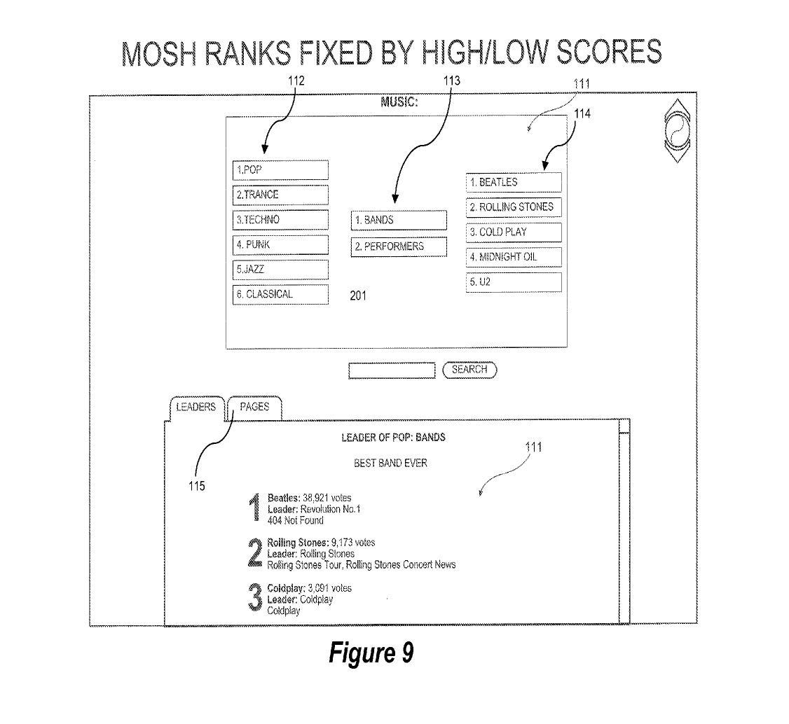

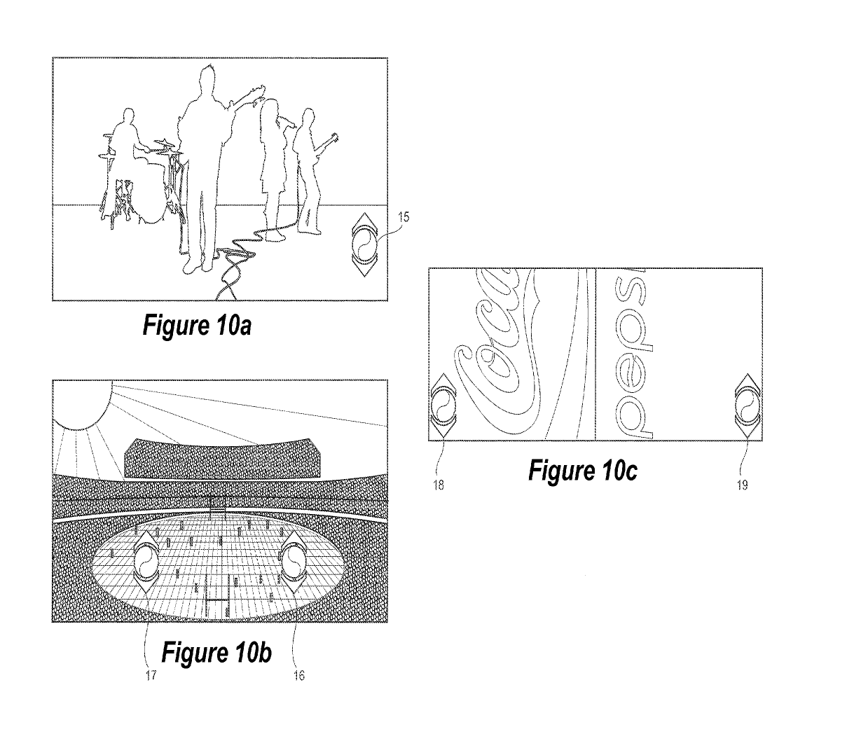

Various views of the results may be provided by the system. FIG. 9 shows one particular view relating to a poll for the “best bands ever”. Reference numeral 110 indicates the linked ballots. Reference numeral 111 indicates the results of “best band ever” poll.

The view of FIG. 9 is presented via a Web interface in this embodiment. The interface presented shows the ballots hierarchically connected and also placed in order of rank. The column of ballots 112 on the left of the drawing has the highest hierarchy and those towards the right are lower in the hierarchy (reference numerals 113 and 114). Ballot 112 (Pop) is a parent ballot of ballot 113 (Bands and Performers). Ballot Bands is a parent ballot of all ballots 114.

This view therefore shows the most popular Bands in the Pop category. Clicking on another of the parent ballots eg Trance would cause a view of the various sub-ballots to Trance, and their appropriate ranking.

Further clicks on a ballot may also enable links to channel partners computer elements eg Web pages, such as blog pages.

A tab 115 allows links to the pages associated with the listed ballots.

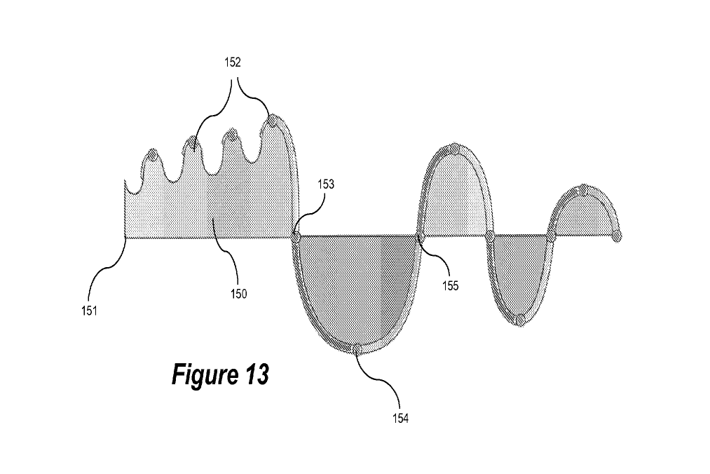

FIG. 13 illustrates how voting can be considered as a contest. Voting up can be countered by a vote down vote. People wanting to see an issue voted down could all vote at the same time or similar times down. People who want to see the issue voted up can view this on their display and can apply their timed vote to vote up.

The view in FIG. 13 (which may be presented as a computer interface, such as a Web interface, by the system) tracks the progress of a ballot over time. At the left 150 of the progress chart, votes are mainly positive, so the progress is shown above the zero point line 151. Various inflection points 152 are shown on the left side of the display, as votes up are being countered by votes down. In this case, the votes up are winning. At point 153 there is a zero crossing, as the number of negative votes starts to outweigh the number of positive votes for this particular ballot.

There is an inflection point at 154 as the number of positive votes start to make headway again and another zero crossing point at 155, and so on. It can be seen that this display provides an active and ongoing representation of the vote “contest”, which will be attractive to participants and provide encouragement for them to vote. In one embodiment, the progress of voting can be tracked in real time.

Ballot results can also be used to rank the ballots in different ways. In one embodiment, as described later, the ballots are ranked based on rules which relate to the amount of votes cast for and against the ballots, and also for and against associated ballots (eg sub-ballots and/or parent ballots in a hierarchy). The rules may mean that the total of positive votes for a ballot (with contribution from sub-ballots) determines the ranking. In another embodiment, referring again to FIG. 13, ranking may only be changed at specific points eg the ranking may change at inflection points and/or at zero crossing points. For example, a ballot may only drop in rank when a zero crossing point occurs. This type of dynamic “contest” may be attractive to voters. Other variations on ranking ballots are possible and the invention is not limited to the total votes ranking process or the zero crossing or the inflection point ranking process.

A series of ballots may have a Current Leader, being the current top ranked ballot. This may be the top ranked ballot of a series of peer ballots. In another embodiment, the leader of a parent ballot may actually be its leading sub-ballot. Or the leader of the parent ballot may be the parent ballot itself (if it has a greater weight than its children). An embodiment may also implement the notion of the highest ever leader (ie the one with the most votes ever) and similarly the lowest ever leader (ie the one with the lowest net votes ever).

Another attractive feature of this embodiment is that ballots need never be closed, so that contests may be maintained, in order to maintain voter enjoyment and also to keep revenue flowing into the system.

It will be appreciated that the interface of FIG. 13 may be animated, in order to show vote progress. Other views and other animations are also possible (eg utilizing Google™ motion charts).

Voters also have the option of retracting their votes in order to affect a ballot result.

Ballots are ranked in one embodiment on the basis of weights of votes directed to the ballots via associated ballots. In this embodiment a tally computing process applies rules to tally the votes and apply weights and rankings to the ballots, as detailed later on in the specification.

If a voter does not wish to maintain a vote in a particular Blog, they can retract their vote (as long as there is voting time period left). The voting device is withdrawn and may be placed in a vote repository for later use. The vote time period only counts down when the vote is placed in a ballot.

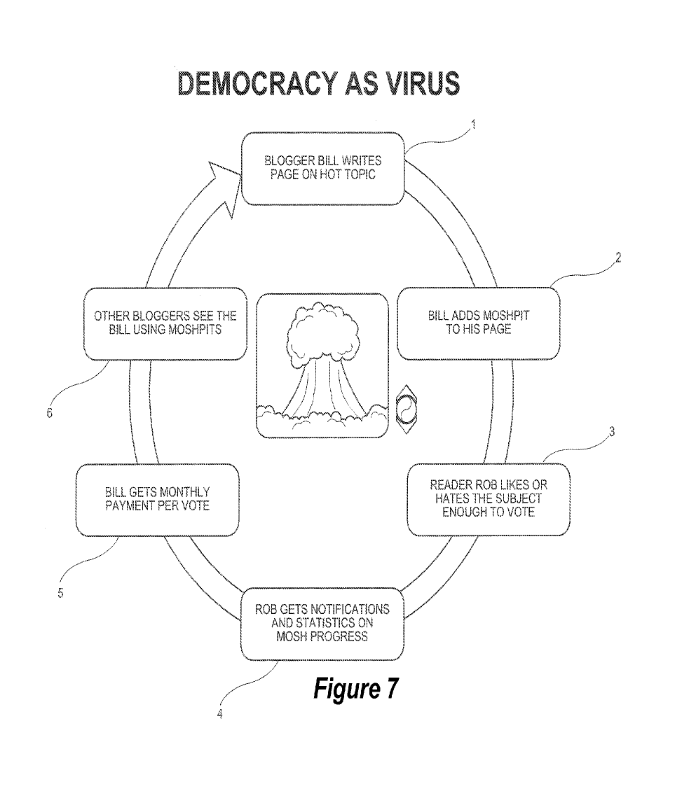

FIG. 7 is a flow diagram illustrating operation of the system with a blog site. At step 1 the Blogger writes a page with content about an important topic. The Blogger accesses the system and adds a voting interface to his page for a ballot relating to the topic (step 2).

A reader accesses the Blog and views the content. The reader is swayed by the content enough to vote one way or the other via the voting interface (step 3).

The system provides notifications and statistics on how their vote is progressing and how the ballot is progressing (ballot results). (Step 4).

The Blogger receives a payment via the system, depending upon how many votes are placed via his voting interface (step 5).

Other Bloggers may view this particular blog and see that it is using voting interfaces. This may encourage them to add voting interfacesto their own pages, in order to obtain kudos and also earn revenue (step 6).

Voting interfaces may be placed on Social sites eg on the walls on owner's of Facebook™ sites, see reference numeral 55. Persons accessing the wall may view the ballot and decide to access the ballot to vote and purchase voting device. Displaying votes publicly on Social networks may encourage people accessing those Social networks to vote (peer pressure).

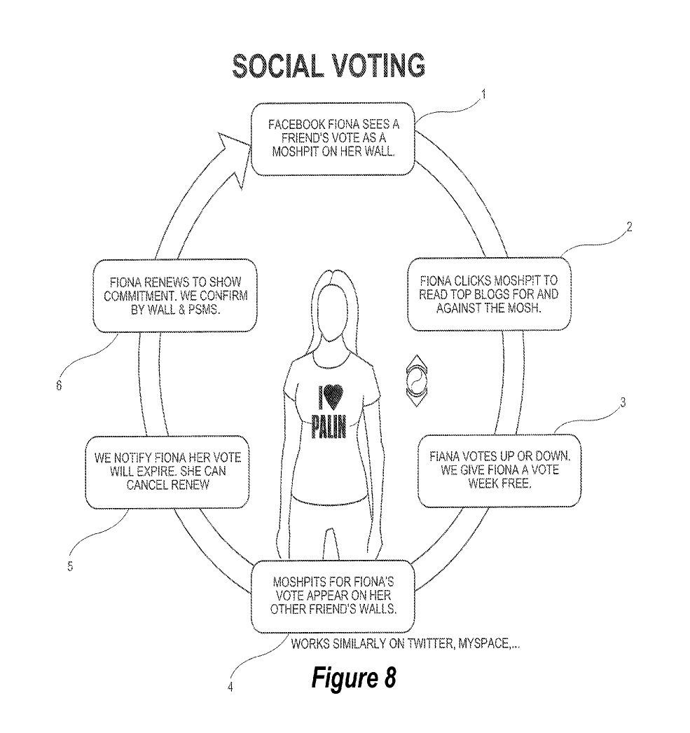

FIG. 8 illustrates how the system may operate in association with Social websites, such as Facebook™.

A Social site user sees a friend's vote as a voting interface on her Wall (step 1). The user clicks on the voting interface, and the system provides links to a top Blog or Blogs or media outlets or equivalent, which includes content relating to the particular ballot (step 2).

The user logs on via the system (see above) and submits a vote (step 3). The user may be given a “free” time period where they do not have to pay for their vote. Subsequently they will be notified that their vote will run out unless they pay.

Voting interfaces for the user's vote are put on the user's friends' walls (step 4).

The user is notified that her vote is due to expire and they will be able to cancel or renew, via the system (step 5).

The user renews to show her commitment to the ballot. The system confirms by Wall and PSMS payment system (step 6).

Social voters on Social sites are encouraged to vote to facilitate relating to other people on the Social site.

The use of social sites can in fact be considered a form of “viral marketing” for spreading voting interfaces enabling access to ballots. When a social site user votes in a ballot, then corresponding voting interfaces appear on friends' social page(s). In this embodiment, this is implemented by the host computing process of the ballot support arrangement. This may be implemented in any social network site, on the Web or social network sites on any other networks. A social network site in this context, is any networked arrangement of sites which multiple users use to interact with each other over a network, and includes sites such as Facebook™, LinkedIn™ and any others.

The following summarizes features of how the system of this embodiment operates, and how results of ballots may be calculated:
1. Each ballot is a poll within a hierarchy of polls, each specializing its parent. Each ballot possesses a name distinct from all its peer ballots.
2. A voting interface includes a portlet registered to a Web page promoting a particular ballot. The portlet serves the function of a voting booth for that ballot. One ballot may be promoted by many different voting interfaces each registered to a different URL, and it is also possible that a given URL may register more than one voting interface.
3. A voting device enables a vote for a ballot lasting for a specific duration and generally promoted by a voting interface. Each voting device is allocated to no more than one ballot at one time.
4. Each voting interface may have one registered Owner, the channel partner who installs the voting interface at its registered URL. The system pays a commission to the channel partner for each voting device voted via that voting interface. The per-diem commission for each voting device ceases when that voting device's duration expires.
5. The net amount of unique active voting devices affecting each ballot at a particular point in time is known as its Net Weight.
6. The tally computer process determines the relative ranks of ballots that share a common parent, whether a sub-ballot is preferred to its parent, and which URL represents each ballot. In an embodiment, it uses the following variables:
   a. DPW=Direct Positive Weight, the number of voters currently actively supporting a Ballot M, ignoring ballots supporting M's descendants.
   b. DNW=Direct Negative Weight, the number of voters currently actively opposing M, ignoring ballots opposing M's parents
   c. DN=Direct Weight=DPW−DNW
   d. APW=Aggregate Positive Weight, the number of voters currently actively supporting descendants of M
   e. ANW=Aggregate Negative Weight, the number of voters currently actively opposing parents of M
   f. AW=APW−ANW
   g. NW=Net Weight for M=DW+AW. This is to say that positive votes propagate up to the ancestors of a ballot, and negative votes propagate down to the descendants of a ballot.
7. A URL also has a Weight per ballot. The URL's Weight in a ballot is the gross number of votes currently voting for or against that ballot through a voting interface on that URL. An interface weighting process is arranged to calculate the weight of the URL (effectively the weight of the voting interface associated with the URL). As discussed above, this URL weight may then be used to calculate a value for payment to the URL owner.

According to a function of their Weights, each ballot obtains a rank within its parent ballot. In an embodiment, the ranking function follows these rules:
1. Only ballots with the same parent are regarded as peers for the purpose of determining relative ranks.
2. Each ballot has a Leading Sub-Ballot. This is the sub-ballot with the greatest Net Weight in that ballot.
3. Each ballot has a Winner. If the Direct Weight of the ballot is greater than the Net Weight of its Leading Sub-Ballot, the Ballot is its own Winner. Otherwise, the Leading Sub-Ballot is the Winner.
4. Each Ballot has a Leading URL. If the Ballot wins itself, this is its heaviest URL. If the Leading Sub-Ballot wins the Ballot, its Leading URL becomes the Leading URL of the Ballot.
5. A URL may contain more than one voting interface. A ballot adds logical context to a URL, so if the Leading URL of a ballot is also present in its parent, the URL Weight in the Sub-Ballot does not aggregate to the URL Weight in the parent. In general the weight of a URL in one ballot is independent of its weight in any other ballot.
6. A user may retract their voting interface from one ballot to another no more than once a day. Upon reassignment of a ballot, the Commission associated with that ballot will no longer be paid to the original voting interface owner.
7. A single voter can only be counted as one vote to a particular ballot at any time. This helps prevent spam and unfair games. If a user votes for multiple descendants of a single ballot, those votes count as only a single vote in the Aggregate Weight of that ballot.

In an embodiment, when a channel partner registers a voting interface, they're required to state whether their URL supports or opposes its ballot. This is called the ballot preference. A Commission for a vote is paid to a channel partner on one of three conditions:
1. When the vote agrees with the ballot preference and the ballot is owned by the channel partner
2. When the vote disagrees with its ballot preference, but the channel partner owns the ballot that is the Ballots Leading URL, and the vote agrees with the Leading URL's preference

The impact and revenue of a Channel Partner page thus depends on its weight within its ballot, then on that ballots weight within its respective containing ballot and so on.

A channel partner page can thus earn revenue depending on the number of votes that are placed via the voting interface associated with the page. This revenue can vary depending upon whether the vote supports the preference of the channel partner page or not. In an embodiment, only votes supporting the channel partner page preference provide revenue to the channel partner. In an alternative embodiment, all votes may provide revenue to the channel partner. Revenue may also depend upon the weight of the channel partner page (URL). If the channel partner page is the leading URL, for example, all votes (negative and positive) may provide revenue to the channel partner. Other variations are possible. It is an advantage, however, that channel partners may earn revenue depending upon the number of votes cast via their associated voting interfaces.

In the case of social voting, in which the ballot is represented as attached to a member of a social network as the result of their vote, that member is regarded as the channel partner, and the ballot preferences is set to agree with their vote.

In the case of social voting, revenue may or may not accrue to the owner of the social page. In one embodiment it is an option that no revenue accrues to the owner. In some cases, it is possible that some revenue may accrue. In the case, for example, where an owner of a social page also sets up commentary on their page relating to a ballot issue. This commentary may encourage other social page owners to vote and revenue could accrue. Any variation is possible within the ambit of the present invention.

In an embodiment of the invention, social media may be made available to users of the system to comment on ballots. Commentary on ballot issues may only be allowed to be entered by such users, however, if the users vote in the ballot. The social media may include social networks, blog pages where users accessing can make comments, or other types of social media. Allowing people to comment in social media only if they vote, encourages people to use the system.

These definitions and rules are intended to encourage Bloggers (and others) and voters to use ballots to promote their common interests rather than their distinct Pages.
By promoting Bloggers' Pages, rather than hosting Bloggers ourselves, we leave Bloggers in control of their own content.
By promoting winning Pages up the hierarchy of ballots we provide an incentive for Bloggers to represent mutually agreeable opinions.
By one-man-one-vote we encourage a socially connected democratic rather than cut-throat capitalist user experience.
By enabling users to reassign votes we provide them with a means to react immediately to changes in Blogger content or real world context. This prevents unscrupulous channel partners from playing bait-and-switch with voting interfaces.

It will be appreciated that the above summary and rules represent one embodiment of implementation of a system in. Many variations of the rules and implementation may be made. For example, weights of ballots may be calculated differently. Only direct weights may be implemented, for example. However, there are other possibilities, as there are with all the other rules.

One point of this embodiment is that users seeking to maximize the leverage of their respective voting devices are naturally obliged to collaborate by placing them together in sub-ballots in order to effectively oppose sub-ballots that represent alternate preferences. The high weight Page could not benefit if it were positioned high in the hierarchy, where it would be required to overmatch the maximum weight of popular Sub-Ballots, respectively, to win.

The prominence of a URL thus depends on its weight within its ballot, then on that ballot's weight within its respective contrary ballot and so on.

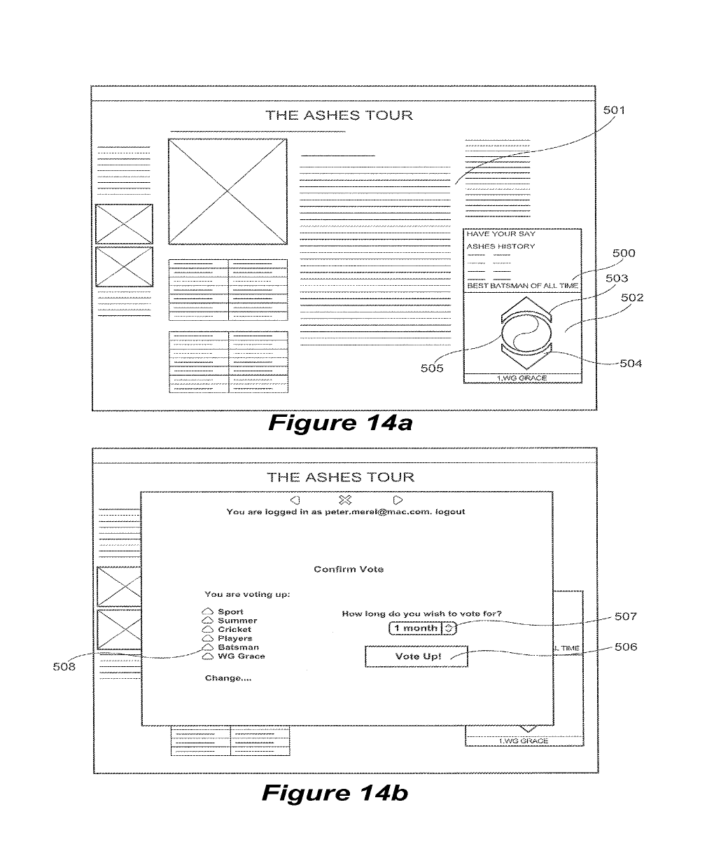

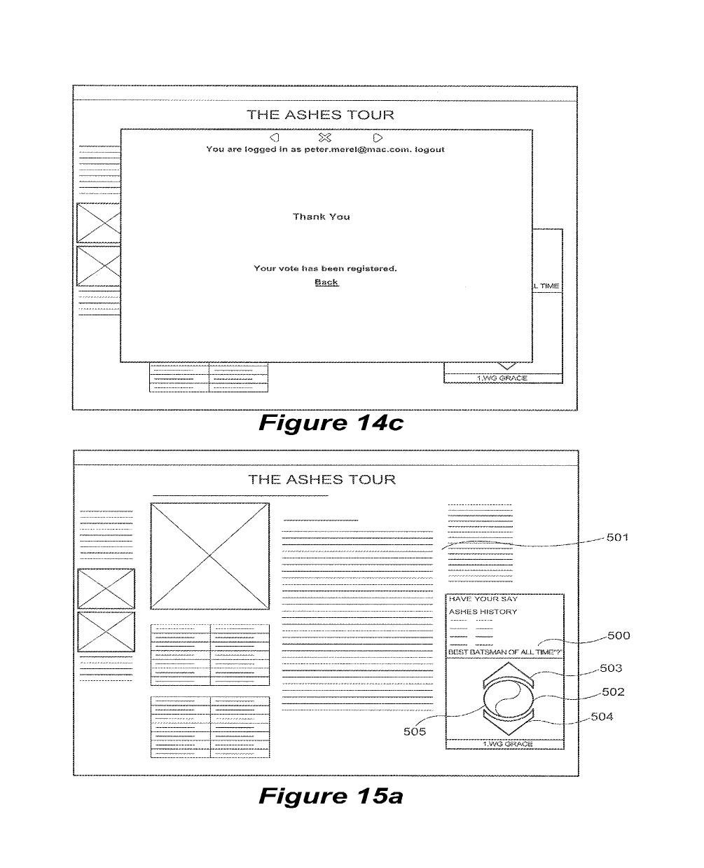

Further illustrations of operation of the system in accordance with this embodiment will now be given with reference to FIGS. 14 through 17.

FIGS. 14a through 14c illustrate Web page interfaces that may be presented to a user who clicks on a channel partner article having an associated voting interface, and decides to vote in the ballot that the voting interface is associated with.

The example shown in FIG. 14a relates to a ballot for the “Best Batsman of All Time”, reference numeral 500. This particular channel partner page has an article 501 discussing WG Grace and an associated voting interface 502 allows the voter to vote for (up arrow 503) or against (down arrow 504) WG Grace as the Best Batsman of All Time. The globe icon 505, in between the up arrow 503 and down arrow 504 allows a user access to the host computing process interface displaying a representation of the Ballot-Space, via which the user may be able to navigate through the ballot hierarchy (see later).

In the example of FIG. 14, the user decides to “vote up”, ie vote for WG Grace. If the user hovers over the vote up arrow 503, this arrow will highlight. When the voter clicks on the vote up arrow 503, a light box interface display “confirm vote”, FIG. 14b, is presented. The voter clicks the Vote Up button 506 to confirm their vote. Also, in the interface presented in FIG. 14b, is a time period box 507 which allows the user to select the voting time period they require for their voting device. In this case, the user has selected one month.

The light box interface also displays at 508 a representation of the ballot hierarchy showing the parents of the WG Grace ballot (in this case being Batsman; Players; Cricket; Summer; Sport). This indicates that if the voter votes Up for WG Grace, they will also be voting Up for all the parent ballots.

When the voter clicks on the Vote Up 506 button, a further interface (FIG. 14c) appears, confirming that the user's vote has been registered. Confirmation of the vote is also sent via the system of this embodiment to the mobile device associated with the user (eg mobile telephone).

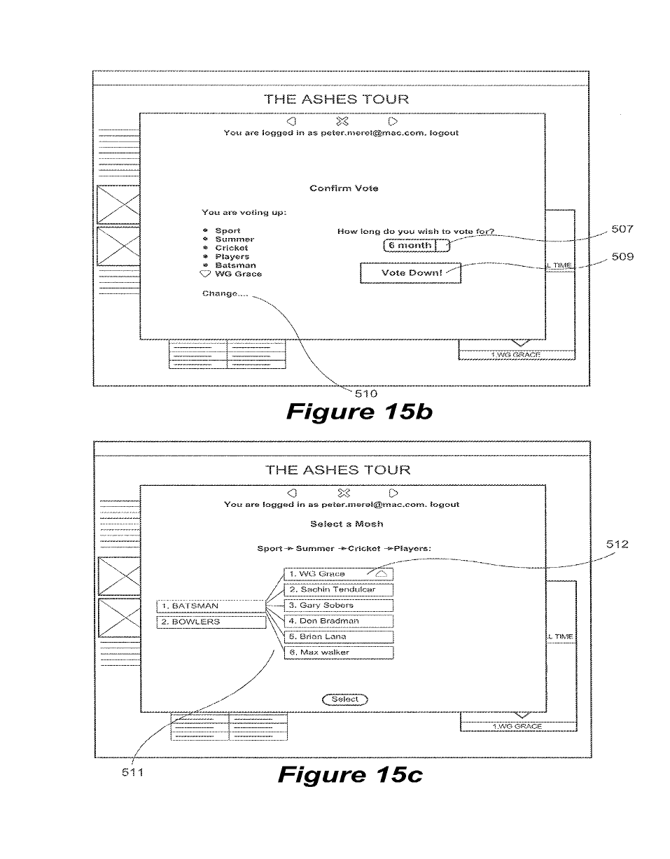

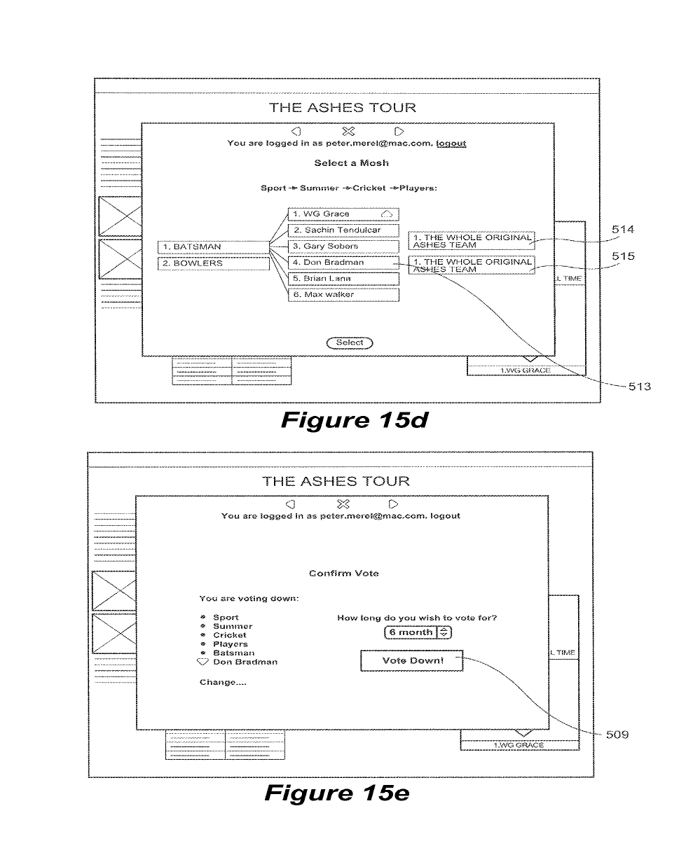

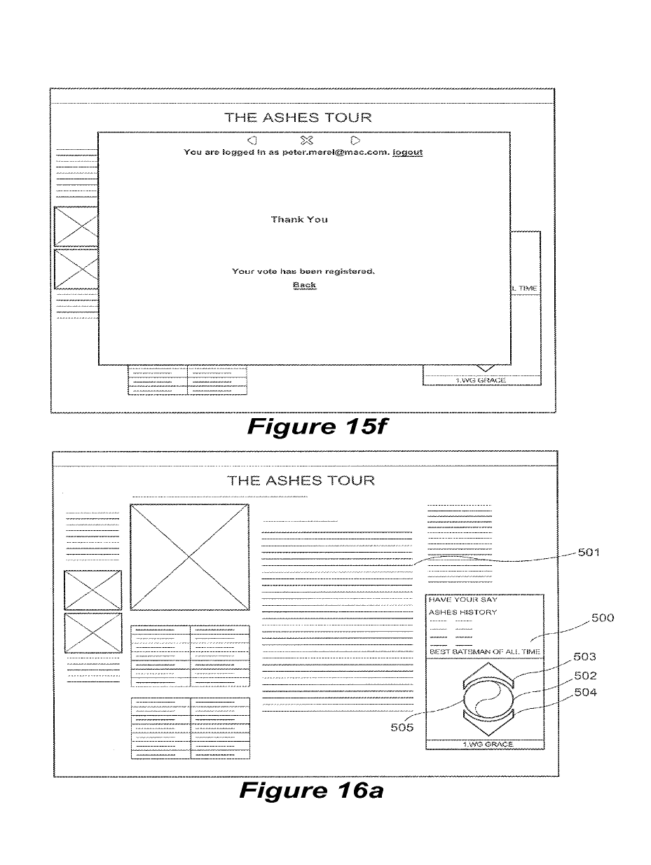

The illustration of FIG. 15, exemplifies the user experience for a user wishing to make a vote, but change their vote.

The user hovers over the Vote Down arrow 504 button (FIG. 15a). This arrow highlights. The voter clicks on the Vote Down arrow 504.

A light box interface is provided (FIG. 15b), including a Vote Down button 509.

In this example, the user wishes to Change their vote.

They click on the Change 510 text in the light box of FIG. 15b.

A further light box appears (FIG. 15c), revealing a representation 511 of a host computing interface representing the ballot hierarchy for this ballot, enabling the user to navigate the ballot. The current ballot 512, WG Grace, is highlighted. The voter clicks on a different ballot, in this case Don Bradman (See FIG. 15d, item 513) to apply their Vote Down. It can also be seen descendent ballots of Don Bradman appear in the light box, reference numerals 514, 515.

Clicking on the Don Bradman box 513 causes a further light box FIG. 15e to appear, so that the voter can confirm their vote. The voter clicks on the Vote Down button 509 and the vote is confirmed (FIG. 15f). Confirmation is also sent to the voter's mobile device.

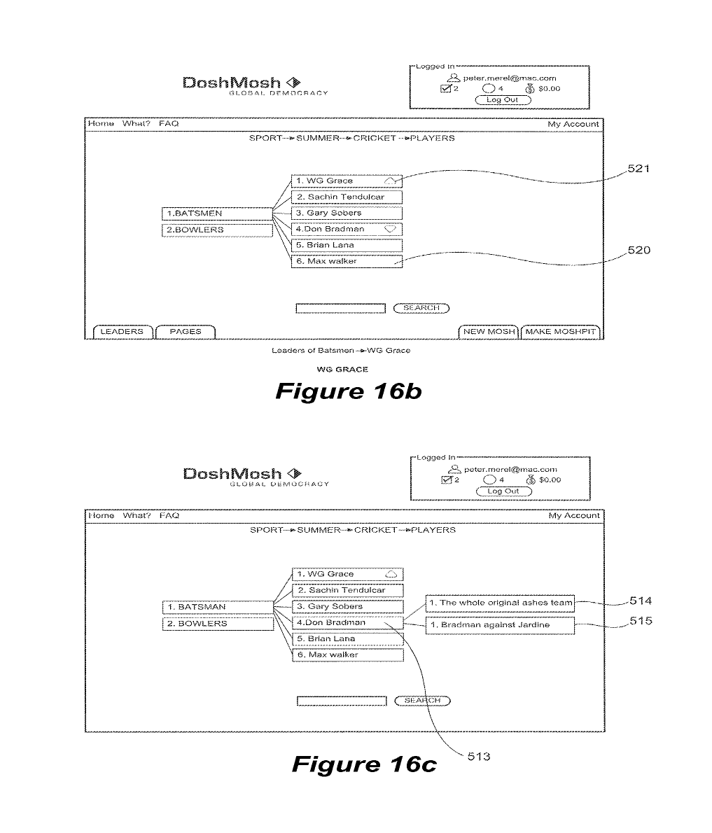

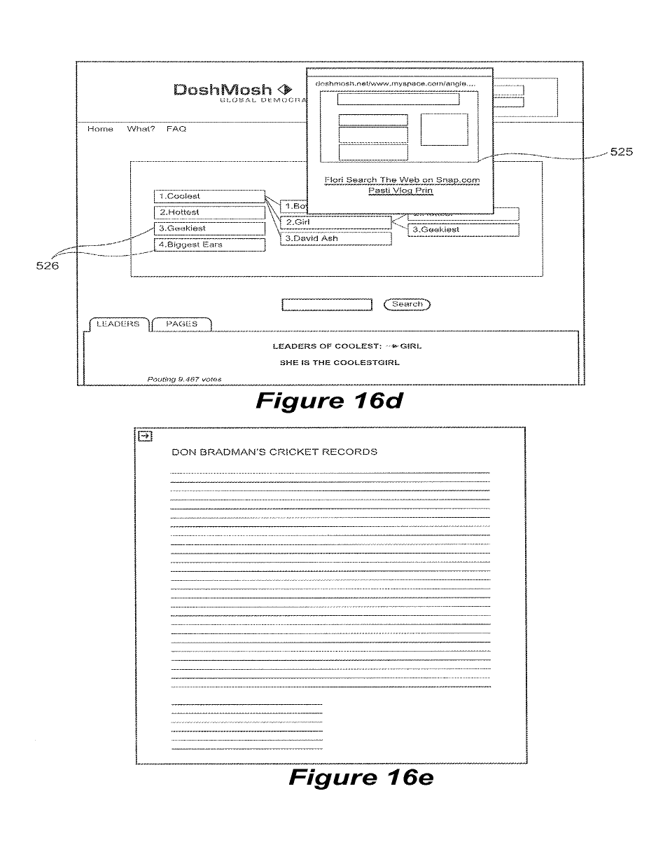

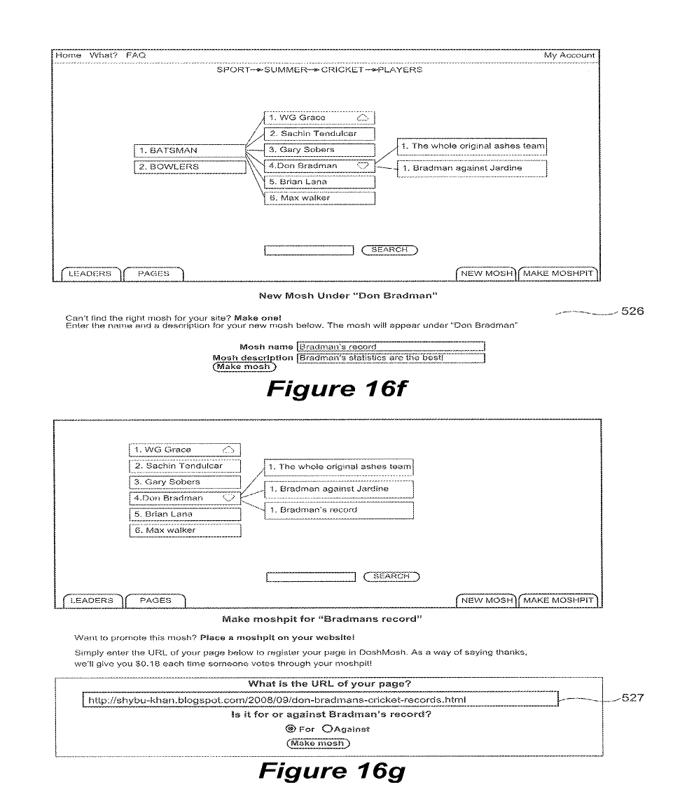

FIGS. 16a to 16i show how a user may explore the Ballot-Space via the host computing process interface. It also shows what a voter might do if they wish to write their own Blog and add a voting interface.

Referring to FIG. 16a, a voter hovers over the globe symbol 505, which highlights. The voter clicks the globe 504 and the browser navigates to the host computing process interface supported a server 8 in the cloud computing system 2. The browser presents the ballot hierarchy 520 with the current ballot 521 highlighted (FIG. 16b). The voter clicks on the ballot Don Bradman 513 to reveal the sub-ballots to Don Bradman, 514 and 515 (FIG. 16c).

The voter may click repeatedly to explore the ballot hierarchy. Hovering over a particular ballot causes the interface to reveal clickable snapshots of pages that have received the most votes in that ballot (see item 525, FIG. 16d). This is a good way of promoting the leading pages of the associated ballot to users exploring the ballot space. Transcluding the leading pages is also a further incentive for channel partners to write cogent commentary on ballot issues. The transcluded page in one embodiment is that of the most influential channel partner ie the one with the most current votes going via the URL at the time. In an embodiment, pages from two channel partners may be linked, being the channel partner with the most positive votes in favour of the ballot and the channel partner with the most negative votes against the ballot. This would mean a user would get immediate access to two opposing opinions relating to the ballot.

The numbering 526 reveals the ranking of the particular ballots (depending upon the weight that has been allocated to the particular ballots by the voting).

The voter learns something from what they've read and decides to write a Blog about it (FIG. 16e).

Wanting to monetize their Blog, the voter, who we now refer to as a Blogger, returns to the host computing process interface (FIG. 16f) and clicks on New Mosh (FIG. 16f) to show how to make a new ballot (item 526, FIG. 16f).

The Blogger registers their page (FIG. 16e) for the new ballot. Note that they could also do the same for an existing ballot just by selecting it and clicking “make Mosh Pit”. Item 527 in FIG. 16g provides a box for the user to enter their URL for their page. The Blogger is then provided with a code to add to their page (item 528, FIG. 16). Once this code is added, a voting interface 529 is created on the Blogger's page 530 (FIG. 16i). Whenever readers of the Blog vote, the Blogger receives some revenue.

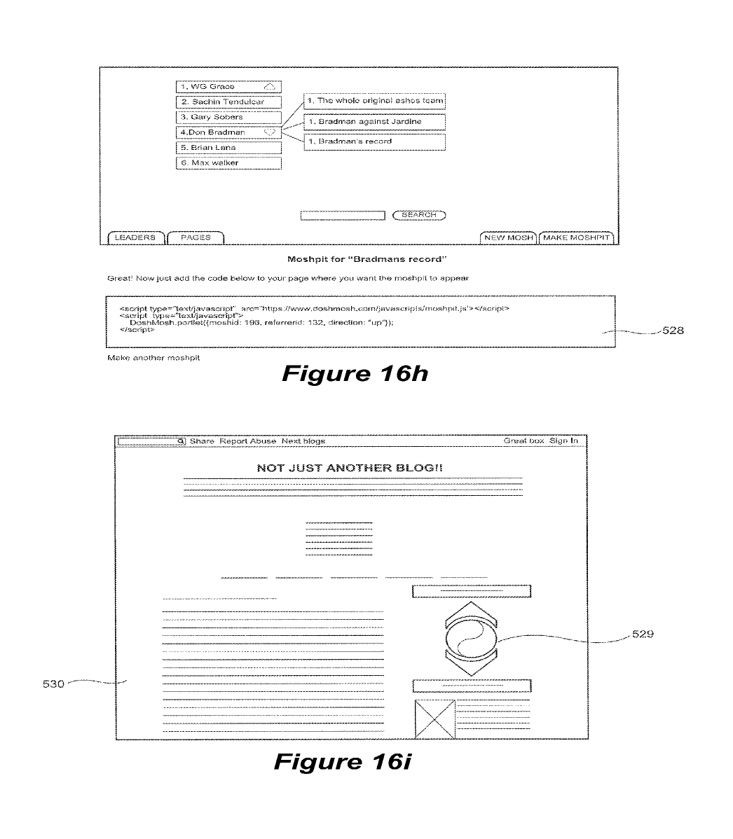

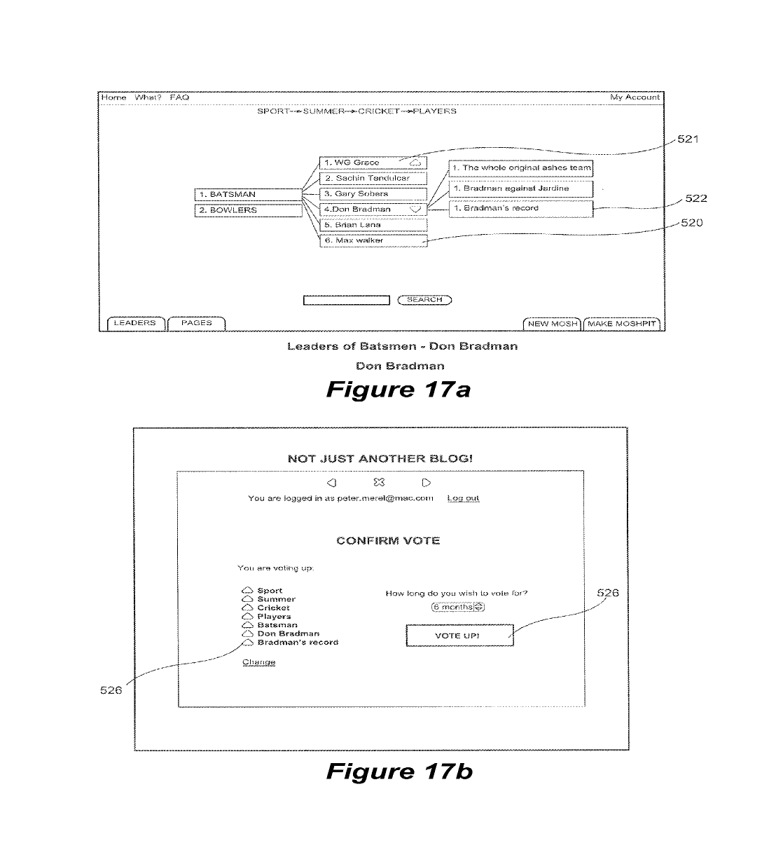

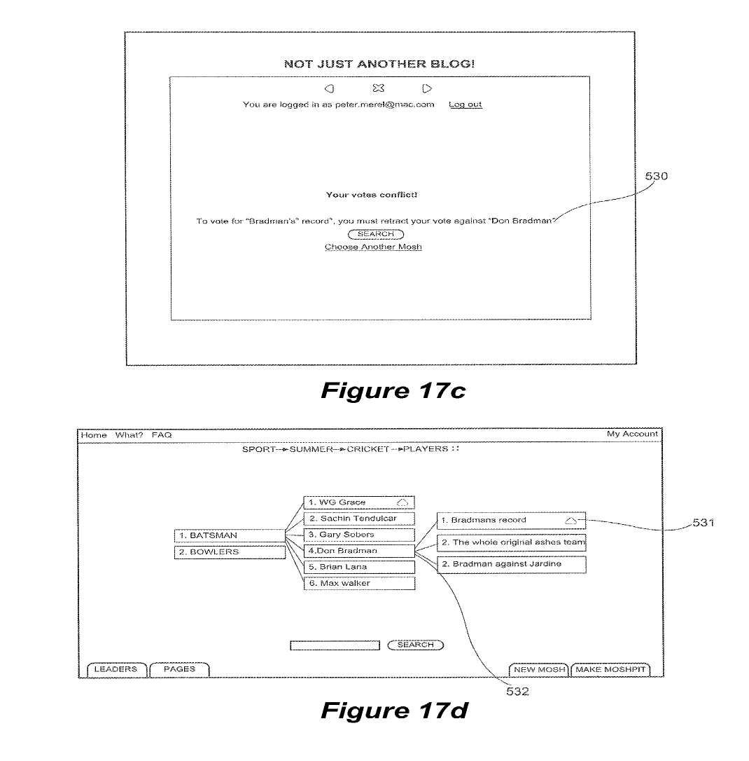

FIG. 17a to d are example interfaces illustrating what may occur in this embodiment of the invention if a voter places a conflicting vote. Referring back to the new voting interface and ballot created by the Blogger in FIG. 16, the Blogger recalls that he voted against the parent of his new ballot (Bradman's Record item 522, FIG. 17a) and will recall that earlier the voter voted against Don Bradman.

The Blogger uses his own voting interface (FIG. 16i, item 529) to vote for his own ballot. The light box appears with a Vote Up button 525 for Bradman's Record 526. The Blogger clicks the Vote Up button 526.

A light box FIG. 17c appears advising the Blogger that their votes conflict and that a vote for Bradman's Record will retract the vote against Don Bradman (item 530, FIG. 17c).

The Blogger returns to the host computer process interface to see the effect of the changes (FIG. 17d). Note that this vote was consequential—it changed the ballot rankings beneath the Don Bradman ballot. This is because neither of the other ballots beneath Bradman presently have any active votes (see item 531, FIG. 17d). Also, the vote against Don Bradman (item 532) has been retracted. The host computer process interface is generated and supported by the host computing system 1, and is accessed via voting interfaces and also may be directly accessed by users. This provides the entire ballot hierarchy and users can navigate through. It also links to content, eg Web pages, as illustrated above. This provides a content hub which is easily navigable, and is a further advantage of this embodiment of the invention.

One of the features of this embodiment is the automatic retraction of conflicting votes. As discussed above, with reference to FIG. 17, if a voter places a vote in a hierarchically connected ballot, and the host computer process determines that it conflicts with a vote that the voter has placed earlier on in one of the hierarchically connected ballots, the conflicting vote previously placed is automatically retracted. In this embodiment, before retraction, the voter is given the option of whether they wish to continue placing the vote and advised that this will result in their conflicting vote being withdrawn. The user may therefore have the option to decide not to place the vote or to place the vote and have the conflicting vote retracted. In an alternative embodiment, the user may not be presented with any option and the conflicting vote will merely be retracted without asking the voter.

One of the requirements of any democratic system is veracity of the ballot process. In an embodiment of the present invention, in order to ensure that the ballot process is transparent, all the data from the vote database, relating to votes in ballots, is downloaded at periodic intervals to a publicly available database. This means that the veracity of any ballot can be checked by third parties. The publicly available interface is supported by the computing system 1 and is available to the public via an audit interface which may be a Website or equivalent distributed computing element.

The audit interface may be provided via a peer-to-peer information sharing network such as bit-torrent or TOR, which allow for high data volumes of the audit information.

The audit information may comprise per-vote and per-voter identity keys (relating to votes by persons identified by their mobile device) that permit voters to verify that their votes are correctly represented.

An advantage of the above embodiment is to enable one vote per ballot per owner, per device (eg mobile phone, or the like). In an embodiment it does this by a process of a transaction via the device so that the identity of the device can be confirmed. A user of the system must hold an account for a device such as a mobile phone, ensuring each vote represents the intent of one authentic human voter, not an automated bot, and the system is such that that vote is only counted once in any ballot. Votes for the same voter may be implemented in other ballots but only one per ballot.

The invention is not limited to one vote, one device, one ballot. In alternative embodiments, users may be able to purchase more than one vote per ballot. In the above embodiment, however, one vote, one ballot, one device is preferred.

A variation on the above embodiment in relation to social media, comprises a rule which allows only people who have voted for or against a particular ballot to make comments in social media. For example, they may make comments for or against a particular Blog, but they are only allowed to do so by the system if a vote is first placed.

In this embodiment, votes have a value, depending upon the vote cost and the vote period of time. The vote value may be in dollars per day (or any other currency) for example. In an embodiment, in order to ensure fairness where the system is implemented in a number of jurisdictions, the value of the vote may vary depending upon the jurisdiction. In one embodiment, the value of the vote is normalized by market according to the Big Mac™ index.

This is the average price of a MacDonalds™ hamburger in each jurisdiction. Normalisation is done in proportion to the Big Mac™ index. Other methods of valuing votes per jurisdiction may be implemented.

In an embodiment, because votes have a value, they may be used as a medium of exchange over networks such as the Internet. They may be used as a medium of exchange for goods and services. This requires the host system to have a method of reallocating votes to users. Users would therefore have to have a device that they could associate with the vote for purposes of identification.

In the above embodiment, the system is shown implementing a ballot hierarchy based on Wikipedia™ and a parent/child type structure. The system is not limited to ballots associated in this way. They may be associated in any way. Votes may propagate between associated ballots in any way determined by the system.

In one embodiment, users themselves (eg bloggers) may generate association ballots by selecting a set of pre-existing ballots and associating them in new ways. For example, a ballot may be associated where positive votes propagate to any association ballot generated from a sub-set of the ballots associated by the ballot A and thereby to the constituent ballots. Association ballot A may be associated with other ballots whereby negative votes propagate to any association ballot generated from a super set of the ballots associated by ballot A. Other variations are possible. Any channel partner, blogger, media partner, etc may be able to associate a plurality of ballots in any fashion they wish to, by selecting the ballots and linking them.

In an alternative embodiment, ballots need not be hierarchically connected at all. Ballots may stand on their own and metered votes may be used to vote for or against the ballot.

In the above embodiment, votes are metered. Whilst this is advantageous, the system is not limited to this. Votes may be unmetered. Ballots may have a finite time period during which votes can be cast. The ballot may be closed once the time period is finished and the result determined.

In the above embodiment, ballots relate to a question for which a positive or negative vote can be made. The system is not limited to this. Ballots could be available for more complex questions eg multiple choice. Other ballot arrangements are possible.

In the above embodiment, the voting interface is presented as an icon having a vote up, a vote down and centre button. The system is not limited to this structure. The voting interface could be presented in any convenient manner.

The voting interface is not limited to being presented as a portlet, as discussed in the above embodiment. It could be presented in a number of ways. It could comprise, for example, a complete web portal, a WAP interface, an iPhone™ application, any API interface, any button placed on a site, eg a button on an Internet site such as Second Life™, embedded within games, game actions/semantics to trigger votes. The voting interface may be presented in any available manner.

Voting interfaces are not limited to being associated with Web pages. They could be associated with any media, advertisement, or any kind of on-line service, any game.

### Improvements and Variations

In accordance with an embodiment of the present invention, some improvements and alternatives have been developed for the ballot system such as previously described.

These improvements and alternatives may be implemented utilizing a similar architecture to FIG. 1, or any alternative architecture ad discussed previously, implementing the functionality described in the following.

In the above embodiment, ballots are hierarchically connected, in one embodiment being in the form of a tree structure. An alternative to this, in accordance with an embodiment of the present invention, is to provide a ballot generating computer process which is arranged to generate linked ballots in response to user input, the structure of the linkage between the ballots being determined based on user input.

In one embodiment, ballots can be formed utilizing Opinions. Each Opinion must have a Subject and one or more Contexts. In an embodiment, implementation is via Subject tags and Context tags.

Users can originate Opinions. Users are motivated to do so by social rewards—votes, points, badges—and by the ability to convert these into monetary rewards.

Each Opinion must have one Subject tag and one or more Context tags. In one embodiment, the system may use a thesaurus to add context tags to a subject. In embodiments, this thesaurus is derived from Wikipedia, Google, or DbPedia. If there is an exact match for a subject or context in the thesaurus this may be used. If there is a disambiguation page, the system may ask users to disambiguate subjects and contexts on this basis. For example http://en.wikipedia.org/wiki/Obama (disambiguation).

If the user insists on using a subject or a context despite the fact that the system has never heard of the word the system warns them, but permits it, augmenting its database of available subjects and contexts.

In an embodiment, the thesaurus is derived in part or in whole from the subjects and contexts other users have already used.

If an Opinion combines a Subject tag with Context tags in some combination we have not previously recorded, we add this to MoshSpace (Ballot Space—note that the invention is not limited to this terminology).

A Context is indicated syntactically within an opinion by prefacing a word or phrase by a sigil character, presently a “#”. A Subject is indicated syntactically by a prefacing a word or phrase with a different sigil, presently a “$”. Note that the characters (#) and ($) are not limiting, and any characters or any other notation may be used in alternative embodiments.

In embodiments, subjects and contexts are denoted by metadata or attached URLs, or various other user interfaces.

An Opinion has a Polarity—it is either positive or negative. In an embodiment these are distinguished by using different sigils,—possibly “−” and “+”. In embodiments, polarity is denoted by metadata or attached URLs, or various other user interfaces.

Users can vote one or more times for or against an opinion. This voting affects the ranking and structure of MoshSpace as described below.

Referring to FIG. 18, this illustrates four Opinions about the subject “Obama” each opinion links the subject to different contexts (see “#” tag). We term the link between the subject and the Context a “Mosh”. Moshes are ballots.

As well as user's being able originate opinions, the system, in the form of the host computer process may “seed” opinions e.g. “seed” them via content partners or on social networks, to start a ballot process.

Referring to FIG. 19, user opinions are attached to a “MoshPit” portlet on any blog page, tweet, or facebook story, of a social network, for example. They may be placed elsewhere.

The ballot space which is built up by using Opinions, Subjects and Context, is not a tree-like ballot space. Opinions are connected by subjects and contexts. This “MoshSpace” is a map from a semi-lattice of contexts nodes to ordered sets of subject nodes. See Wikipedia at http://en.wikipedia.org/wiki/Semilattice and http://www.rudi.et/books/200 and http://www.rudi.net/books/201 for articles discussing semi-lattices.

An Opinion links a single subject to a singe node in the context semi-lattice and thereby to all of its ancestors in MoshSpace. MoshSpace is in large part virtual which is to say that context nodes that are not directly mapped to a Subject node need not be explicitly represented.

The most elemental nodes in MoshSpace are called its Primes. Primes can denote a semantic distinction, a calendrical distinction, a temporal distinction, a geographic distinction, a spatial distinction, or a distinction between process behaviors.

As in the earlier embodiment, positive votes propagate upward in the Context Semi-Lattice while negative votes propagate downward.

In an alternative embodiment, because this is not a hierarchical lattice, both positive and negative votes may propagate upwardly.

### MoshSpace Example

An Opinion:

“$Obama is the best choice for #American#President in #2012”

Is represented in MoshSpace by a link between the subject node $Obama and the Context node #2012+#American+#President. This implicitly links $Obama to context nodes #2012+#American, #American+#President, and #2012+#President. It also implicitly links $Obama to a prime nodes #2012, #American and #President.

### Moshes & MoshPits

A Mosh represents a single node in the MoshSpace semi-lattice along with the set of all subjects that pertain to the node or to any of it descendant nodes.

A MoshPit represents a Mosh and enables users to vote for or against any of its subjects.

A MoshPit is usually based upon a single opinion but exposes the user to opinions on all subjects in the Mosh.

### Mosh Example

An Opinion:

“$Obama is the best choice for #American #President in #2012”

will generate a Mosh representing all the subjects that link to the MoshSpace node #2012+#American+#President. This may include subjects such as $Hillary-Clinton, #Michelle-Bachmann, $Dennis-Kucinich, $Ron-Paul and $Sarah-Palin.

If the Opinion instead was

“$Obama is the best #Democratic choice for #President in #2012”

Then only $Hillary-Clinton and $Dennis-Kucinich might show up as alternative subjects in this Mosh.

### Content

Content may be associated with ballot/opinion. As discussed above content may be added by bloggers. It may also be added by other channel partners such as media partners. A user preparing an opinion may add content (e.g. a blog or video content or any other media content). Any content may be added by a user, channel partner, media partner etc. Clicking on a Mosh may enable access to the content which is associated with the opinion.

In an embodiment, a media partner or channel partner could bid to attach content to a particular opinion or opinions. Advertising could alternatively or additionally be connected with opinions. This could attract revenue from channel partners. Votes may therefore be “monetized” based on cents per click, for example, (or other charging methods), charges to content providers, including news media and blockers. Content embedding may be auctioned to determine an amount of charge, for example. Subject and Context tags could be used to find people whose opinions agree and can also be used to filter the content associated with those Subject and Context tags to those people. This has the advantage of facilitating connection of content with persons that have shown their interest in it because they have voted on a particular opinion, accessed a particular MoshPit etc. Media partners can therefore reach the people that they want their media to reach i.e. people that are interested in the particular context/subject that the content may relate to.

Another improvement/variation relates to how votes are tallied and used. The system includes a value processor arranged to calculate a value which may be paid to a user. Value may depend on “weight” and “karma”. Note that the term “karma” is purely terminology used in this embodiment.

In an embodiment, as an attribute of opinions Karma can be used to order the presentation of opinions in a MoshPit. As an attribute of Subjects within a context, Karma can be used to order the presentation subjects in a ranking (and in a histogram or motion chart, etc. based on same). As an attribute of a user, Karma can be used to determine whether the user can cash out vote devices to receive a reward, and to determine the size of a reward.

Karma can also be used to determine the eligibility of subjects for a Race (see later). Karma can also be gauged and ascribed to calendar time and location better context, and per subject within a context, to produce a heat-map or compass (or other display) overlay to a map or calendar representation.

### Karma

Each opinion has a total of agreeing and disagreeing votes. The total votes agreeing with an opinion are called its Positive Karma. The total votes disagreeing with an opinion are call negative Karma

An opinion's Net Karma is defined as its Positive Karma minus Negative Karma.

An opinion's effective Karma is defined as its Net Karma times its Polarity.

An Opinion's Weight is defined as its Positive Karma plus its Negative Karma.

The Karma of a Subject in a Mosh is defined by the sum of the Effective Karma of all Opinions that share that Subject and the Mosh's Context.

The Weight of a user is defined as the sum of the Weight of all Opinions they originate.

MoshPits list all the subjects in a Mosh in order of their Effective Karma.

MoshPits list all the Opinions in a Subject of a Mosh in order of a function of their Weight.

### Karma Example

Imagine Alice creates two opinions “$Obama for #President #2012” and “Don't vote for $Bachmann for #President!!!”. She marks the first opinion as positive, the second opinion as negative.

Bob, who hates both Obama and Bachmann for President, sees Alice's opinions turn up in a MoshPit. Bob votes once against Alice's first opinion and twice for her second opinion.

The net karma of the first opinion goes down by 1 and the net karma of the second opinion goes up by 2. And the result of Bob's votes is that Alice's personal karma goes up by 1.

Because of Bob's vote against Alice's first opinion the karma of $Obama in #President+#2012 goes down by 1. Note that the negative votes propagate down the semi-lattice while positive ones propagate up. So Bob's vote doesn't affect the karma of $Obama in #President or in #2012.

The reason for this is that, perhaps, Bob thinks Obama was a great President in 2008, but likes Kucinich better for 2012. We cannot guess at this kind of thing so we will want to make it obvious graphically for Bob to see the effects of his votes.

The second opinion was negative so because of Bob's 2 votes for that opinion the karma of $Bachmann in #President goes down by 2.

Karma promotes opinions, yields badges, votes and cash (vote may be monetized for cash).

In an embodiment, results are ordered by karma so that spam ballots become invisible.

### Voter Rewards

Users can be rewarded based on measurements of changes in their Karma, their Weight, of the Karma and Weight of their opinions, or of the Mosh ranking of subjects of their Opinions.

These rewards usually take the form of votes. Votes can be used in MoshPits or converted into cash at a rate that is a function of total pool of system income and the total number of uncast votes.

Users are also rewarded with votes in exchange for their performing one of 4 actions:
Initially authenticating themselves, typically via Oauth provider like Facebook, Twitter or Google, by their purchasing our free app from an app store (usually via Apple, Android or Google), or via a mobile phone interaction (PSMS, WAP or IVR). This initial authentication typically occurs only one time per user.
Subscribing to the system premium service. The system offers to subscribe user's to a feed of votes per day in exchange for providing a micropayment. This micropayment transaction is typically conducted via Amazon, Paypal, Apple, Premium SMS or WAP billing. Various game dynamics may motivate a subscription.
Creating a new Opinion. Typically this will result in a reward of 2 votes—on dedicated to the new Opinion, on available for voting on any Opinion. Users may be limited in the number of new Opinions they create per day
Daily activity—see XATS

### XATS

Votes that disagree with an Opinion reduce the net Karma of that Opinion and of its owning user. Over the course of a day we sum all these disagreeing votes and then subtract a number corresponding to the amount of channel partner margins we have had to pay out in the course of the day.

This yields a number we call Total XATS (XATS is Backward Taxes . . . ). We divide this number by the number of users that were active on the day, and award that many votes to each active user, thereby motivating them to return every day to use or cash in their votes on a regular basis.

If a user is not active on a particular day he does not receive any XATS for that day, but still has XATS waiting for him from the last day he was active. Measures of activity include opining and voting.

In the preferred embodiment of the invention of PCT/AU2011/000761, the votes are metered votes, being associated with the time they are valid for. Metered votes may be used in these improvements and alternatives, but in this embodiment, votes are not metered. Further, a single user may vote more than once. In this way, therefore, they may affect the outcome of ballots based on numbers of votes. They also may try and get their friends to vote for an opinion there in favor of, for example. In one embodiment, the system is arranged to implement specific ballots which are time limited, termed “Races”.

### Races

Once per week we select a percentage of the highest weight Moshes to participate in a special competition called a race. There are two differences between a race and a regular Mosh:

1) Only micropaid votes are counted
2) Race mosh rankings are frozen for a year
3) Voters for race winners are rewarded with higher rates of XATS and with badges

Races may also be requested by users, or instigated in other ways.

### Golf Race Example

On facebook Bob notices his friend Alice has an opinion that his local golf course should be converted into a public park:

“#Susquehana-golf-course at #[location tag] should become a $public-park so my children can play there.”

Bob, an avid golfer and candidate for president of the golf club, has plans for its expansion. He writes a long piece about this on his Susquehana golf blog and attaches the URL to an opinion:

“#Susquehana-golf-course should be eternally dedicated to the noble pursuit of $golfing-only. But the general public should be freely admitted at all competitions and exhibition matches.”

Alice marshals her Tupperware and knitting circles and gets a letter on the subject with the Mosh URL into the council. Bob, incensed, raises the matter with the golf club AGM.

Soon there are hundreds of opinions vying for supremacy in #Susquehana-golf-course. Golf lovers and park lovers from around the world take an interest and his most enter a championship. It looks like $public-park is losing but Alice is determined. Most of the karma it is getting comes via her original opinion, and she does not re-vote the reward votes, but saves them up to cash in at the right time. With the proceeds she runs a full page ad in the SMH complete with pictures of gory golfing injuries.

Bob loses in a landslide. Muttering under his breath he puts up a new opinion about disposition of toxic chemicals used at Alice's hair salon . . . .

FIG. 21 shows another MoshPit example relating to the opinion of who was the best actor in a particular movie. People may vote for the actors as indicated. Content may be associated with this particular Mosh e.g. scenes from the movie may be associated, so that users can view the scenes before voting. If the weight of this Mosh is high it may be nominated as a race.

In an embodiment, the system includes a behavior assessment process, which is arranged to assess the behavior of users. In this embodiment, the voting and opining behavior of users may be assessed as a pattern, termed “karmic pattern” (it will be appreciated that the invention is not limited to this terminology).

### Karmic Patterns, Filters, Friends and Foes

Karmic patterns are patterns of voting and opining behaviors of users. The semi-lattice of contexts in MoshSpace enables the system to determine cliques of users whose voting and opining behaviors most resemble one another, and who are most dissimilar from on another.

The system may present Opinions and Moshes to a user that best fits their Karmic pattern, even when these Opinions and Moshes do not originate from people on their social network.

The system also present the user with lists of people whose karmic patterns are most similar and most different from his karmic pattern, along with the Moshes that are the present focus of their voting and opining behaviors. This enables users to find groups of people who agree with them, and to use their votes to most effectively compete against groups of people who disagree with them.

Continuing the golf race example, Bob sees a stream of opinions from Susquehana golfers on Moshes unrelated to the public park conversion. Bob supports many of these opinions to curry favor, strengthen his karmic network, and gain visibility for his opinions among the followers, friends and karmic allies of the opinion holders.

Patterns of voting and opining behavior can be used to connect users with other users who have similar interest to stream content to users who have particular interests and are likely to have interest in the content may be advantageous to users who wish to connect with people who are interested in the same things as themselves, and to find information on the subject that their interested in. This is an extremely advantageous way of connecting content/people together, whereas they otherwise would not be connected. Social voting represent a unique value proposition to the social network user. The system has the potential to connect the user to other users who agree with them about a particular opinion(s).

Another improvement in this embodiment is the provision geographic association process which is arranged to associate opinions, Moshes, Subjects etc with geo locations. This process can also connect people that have similar opinions and are in the same geo location, for example. People have access to mobile device which also provide geo location information. The system uses these to determine geographic information and also provide opinions, Moshes, etc that are associated with a particular geographical location.

### Mobile Moshes

The system can field clients on a wide range of mobile devices including all popular brands of smart-phone but also cars, watches, anything that can indicate a location and a time.

The voting interface on these clients may be programmed to vote positively or negatively upon user gestures determined by accelerometer measurements, upon manipulation of a touch-sensitive interface, buttons, audio input, video input, or some combination of these.

Opinions may also be entered as audio or video recordings and a subject and context may be added to these by searching and selecting from menus.

The system mobile client exposes its users to a sequence of Moshes filtered by location, date, time of day, and similarities in karmic pattern.

The user may use the system mobile client to edit, narrow or broaden the range of criteria whereby these filters are applied. The user may also use the client to search for Moshes that would otherwise remain outside his filter criteria.

Content partners may also pay the system to selectively expose users to Moshes and other content relevant to a range of times, places and karmic patterns that would not otherwise meet the user's filtering criteria. The system will indicate to the user that such content derives from a content partner rather than from an ordinary user, and enable the user to filter out various kinds of “spammy” content.

### Mosh Nets

It is also possible for a content partner to define streams or networks of Moshes related by patterns in time and space. For example, Moshes relevant to the sequence of scenes in a movies playing at particular times of the day in particular cinemas. We call such network of Moshes a Mosh Net.

A system mobile user can select the Moshes or Mosh Nets to which his subsequent votes or opinions will apply so long as those Moshes or Mosh Nets conform to a certain range of karma patterns, space, time and authentication group,

A user may also be permitted to define Moshes that are invisible to users whose behaviors do not conform to a certain pattern of karma, space, time, or authentication group.

The point of this being that, using default settings for these parameters, users may vote positively or negatively in Moshes that concern them with minimum of effort. A movie viewer observing scenes in a particular cinema or feed is able to vote for or against the subjects of each using simple gestures or touches on their mobile device.

Continuing the Golf race example, Bob visits a PGA competition and votes for his Mosh there. Fellow golfers at the event, incensed at the idea that their course may be threatened, vote for Bob's opinion. The GGA Mosh Net makes Bob's opinion visible at the next PGA event even though Bob does not attend.

### Contagious Mobile Moshes

If a user opines or votes for a Mosh in a location at point in time on a date of the calendar, the Mosh in which he votes can be presented to other Mobile system users who visit that location or related locations at a related time and date, with related karmic patterns.

In addition, if two Mobile system users are colocated, the Moshes that have received votes or opinions from the one user can be presented to the other user, and vice versa.

The presentation of co-located Moshes can also be filtered by the user applying various karmic criteria, by relative Mosh rank, and by the recency of votes and opinions relevant to those Moshes.

Continuing the Golf race example, Bob takes a golf party to each hole of the Susquehana course, voting for his Mosh from every one of them, ensuring that casual golfers who don't know about the controversy can vote on it when they use their system app to vote for or against the quality of each tee and green.

### Karmic Content Segmentation

We're used to newspapers and encyclopaedias targeting a neutral point of view or lowest common denominator audience. But the system enables content partners to attach content to opinions with multiple different points of view each targeting multiple different audience segments, each customised by subject and audience karmic pattern. Such content segmentation can also target patterns of location and calendar event.

The key benefit to this is that content can be channelled directly to people who have no connection at all to the content provider—they are not readers of the provider's site, they are not friends of readers, and they may not even know the content provider exists at all. But they have voted for or against the subject of the content in a relevant context, and that's all we need to know to know they'll be interested in the content.

We can also create a karmically filtered content hub using this technique. Similar to Wikipedia or Google News but filtered to provide representations whose target audience agrees with the karmic pattern of the reader.

### Augmented Reality Control

Localised Moshes can control shared resources—A/C settings, café music, road traffic configuration, and augmented reality game media.

The latter is important because in the next decade augmented realities will become ubiquitous. The only thing holding them back now is adequate display devices, and there's plenty of work going on with those.

Right now people are content to use various game mechanics to determine what media will occur where in VR games. But when they come to spend most of their time in collaborative AR they will need to have a way to equitably arbitrate and segment the content of shared spaces.

Continuing the Golf race example, ten years after the conversion of the Susquehana course Alice's son Carl writes an AR application that converts an ordinary pair of sunglasses into a virtual golf course. Using old photos Carl lays out the original arrangement of the Susquehana course and invites Bob to use his extensive Karmic net to help launch the game.

Old Bob often plays virtual golf through the groups of children playing in the park. But the children never see him because, to their karmic pattern, he looks like nothing but a frowzy old lion trying to find a sunny spot in which to fall asleep.

FIG. 23 is a flow diagram showing how social voting may be used to vector opinions and content.

FIG. 24 shows how mobile location may be used to vector content and Moshes/Opinions.

FIG. 25 shows how online use may be used with the system and karma filtered etc.

The following example is of use of the system via a social network application such as Facebook™. This is just one interface into the system, and other interfaces may be implemented e.g. other social networks, and other interfaces.

### Example

Note that in this example, the terminology “DoshMosh” refers to a system in accordance with an embodiment of the present invention.

In the above embodiment, the system is shown with network interfaces based on the Worldwide Web. The system is not limited to this, any network architecture may be used to implement embodiments of the present invention and it is not limited to the Internet.

In the above embodiment, the system is implemented via the Internet. The system is not limited to this. Embodiments may be implemented by other Wide Area Networks, or Closed Area Networks. Other networks may be connected into the system in addition to the Internet, for example. A closed network or intranet may implement an interface (eg API) to the host computing process utilizing applications operating in the closed intranet eg implementing voting interfaces using different computer software/hardware than that used in the external network. Other variations are possible.

It will be appreciated that the components of the system, such as voting device, voting interface, ranking process, valuing process, host computer process, vote repository, tallying process and other components may be implemented in program code and by appropriate programming of computing devices. The program code may be supplied in a number of ways, for example, a computer readable medium, such as a disk or a memory or as a data signal.

In the above embodiments, the system is hosted via a “cloud” computing system. The invention is not limited to this. The system may hosted on a proprietary computer system, or other computer architecture may be utilized.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1-13. (canceled)

14. A computer based ballot system for facilitating operation of ballots, comprising:
a computer processor configured to:
host a ballot,
register and tally votes on the ballot in response to operation of a voting device,
effect a vote in the ballot, and
generate a linkage between the ballots in response to user input, the structure of the linkage between the ballots being determined based on user input; and
a computer database configured to store at least the votes on the ballot.

15. The computer based ballot system in accordance with claim 14, wherein the computer processor is further configured to generate the linkage in the form of Opinions based on the use of Context and Subject for each Opinion.

16. The computer based ballot system in accordance with claim 14, wherein the computer processor is further configured to determined patterns of voting and/or opining behavior of users of the system.

17. The computer based ballot system in accordance with claim 14, wherein the computer processor is further configured to associate a geographic location with the ballot or a Subject of the ballot.

18. The computer based ballot system in accordance with claim 14, wherein the computer processor is further configured to generate the linkage in the form of a plurality of Opinions based on the use of a Context and a Subject for each of the Opinions.

19. A method of arranging ballots, the method comprising:
registering and tallying votes on ballots in response to user ballot input; and
linking the ballots in response to the user ballot input, the structure of a linkage between the ballots being determined based on the user ballot input.

20. The method of arranging ballots in accordance with claim 19, wherein the linking comprises generating the linkage in the form of Opinions based on the use of Context and Subject for each Opinion.

21. The method of arranging ballots in accordance with claim 19, further comprising assessing behavior of users based on patterns of voting and/or opining behavior of users.

22. The method of arranging ballots in accordance with claim 19, further comprising associating a geographic location with the ballot or a Subject of the ballot.

23. The method of arranging ballots in accordance with claim 19, wherein the linking comprises generating the linkage in the form of a plurality of Opinions based on the use of a Context and a Subject for each of the Opinions.

24. A non-transistory computer readable medium configured to provide instructions for controlling a computer to implement a computer based ballot method comprising:
registering and tallying votes on ballots in response to user ballot input; and
linking the ballots in response to the user ballot input, the structure of a linkage between the ballots being determined based on the user ballot input.
